(19) United States
(12) Patent Application Publication
(10) Pub. No.: US 2024/0085816 A1
(43) Pub. Date: Mar. 14, 2024

(54) ELECTROSTATIC IMAGE DEVELOPING WHITE TONER, ELECTROSTATIC IMAGE WHITE DEVELOPER, WHITE TONER CARTRIDGE, PROCESS CARTRIDGE, IMAGE FORMING APPARATUS, IMAGE FORMING METHOD, AND ELECTROSTATIC IMAGE DEVELOPING TONER SET

(71) Applicant: FUJIFILM Business Innovation Corp., Tokyo (JP)

(72) Inventors: Teppei YAWADA, Kanagawa (JP); Kotaro YOSHIHARA, Kanagawa (JP); Asafumi FUJITA, Kanagawa (JP); Tomoaki TANAKA, Kanagawa (JP); Tsuyoshi MURAKAMI, Kanagawa (JP)

(73) Assignee: FUJIFILM Business Innovation Corp., Tokyo (JP)

(21) Appl. No.: 18/462,948

(22) Filed: Sep. 7, 2023

(30) Foreign Application Priority Data
Sep. 12, 2022 (JP) 2022-144896

(51) Int. Cl. G03G 9/09; G03G 9/08; G03G 9/087

(52) U.S. Cl. CPC G03G 9/0926; G03G 9/0819; G03G 9/08755; G03G 9/08797

(57) ABSTRACT

An electrostatic image developing white toner includes white toner particles including a binder resin and a white coloring agent; and an external additive including poly(meth)acrylate particles, wherein the white toner particles have a volume-average particle size D_{50W} of 6.0 μm or more and 10 μm or less, a ratio of the white toner particles having a particle size of 3.2 μm or less relative to all the white toner particles is 0.5 vol % or more and 3 vol % or less, the white toner particles have a specific surface area S_{w} of 0.7 cm²/g or more and 1.2 cm²/g or less, and an external addition amount of the poly(meth)acrylate particles relative to the white toner particles is 0.1 mass % or more and 2.0 mass % or less.

### CROSS-REFERENCE TO RELATED APPLICATIONS

This application is based on and claims priority under 35 USC 119 from Japanese Patent Application No. 2022-144896 filed Sep. 12, 2022.

### BACKGROUND

### (i) Technical Field

The present disclosure relates to an electrostatic image developing white toner, an electrostatic image white developer, a white toner cartridge, a process cartridge, an image forming apparatus, an image forming method, and an electrostatic image developing toner set.

### (ii) Related Art

In electrophotographic image formation of the related art, for the purpose of forming color images on color recording media or permeable recording media, white toners are used, which is known.

For example, Japanese Unexamined Patent Application Publication No. 2018-077359 proposes “an electrostatic image developing toner including white toner base particles containing a binder resin and titanium oxide particles having an average particle size of 130 to 600 nm, and an external additive including strontium titanate”.

For example, Japanese Unexamined Patent Application Publication No. 2020-129043 proposes “an image forming method including a step of collectively transferring a white toner and a color toner to a recording medium and fixing the toners to form an image, wherein, in an environment at 20° C. and at 50% RH, at 100 kHz, the dielectric loss tangent of the white toner defined as tanδw100k and the dielectric loss tangent of the color toner defined as tanδc100k satisfy Formula (1): tanδw100k<tanδc100k”.

### SUMMARY

Aspects of non-limiting embodiments of the present disclosure relate to an electrostatic image developing white toner including white toner particles including a binder resin and a white coloring agent and an external additive including poly(meth)acrylate particles, the electrostatic image developing white toner providing, even in repeated formation of low-area-coverage images, white images in which lowering of the whiteness is suppressed, compared with cases where the white toner particles have a volume-average particle size D_{50W} of less than 6.0 μm or more than 10 μm, the ratio of the white toner particles having a particle size of 3.2 μm or less relative to all the white toner particles is less than 0.5 vol % or more than 3 vol %, the white toner particles have a specific surface area S_{W} of less than 0.7 cm²/g or more than 1.2 cm²/g, or the external addition amount of the poly(meth)acrylate particles relative to the white toner particles is less than 0.1 mass % or more than 2.0 mass %.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing white toner including:
white toner particles including a binder resin and a white coloring agent; and
an external additive including poly(meth)acrylate particles,
wherein the white toner particles have a volume-average particle size D_{50W} of 6.0 μm or more and 10 μm or less,
a ratio of the white toner particles having a particle size of 3.2 μm or less relative to all the white toner particles is 0.5 vol % or more and 3 vol % or less,
the white toner particles have a specific surface area S_{w} of 0.7 cm²/g or more and 1.2 cm²/g or less, and
an external addition amount of the poly(meth)acrylate particles relative to the white toner particles is 0.1 mass % or more and 2.0 mass % or less.

### BRIEF DESCRIPTION OF THE DRAWINGS

Exemplary embodiments of the present disclosure will be described in detail based on the following figures, wherein:

FIG. 1 is a schematic configuration view illustrating an example of an image forming apparatus according to an exemplary embodiment; and

FIG. 2 is a schematic configuration view illustrating an example of a process cartridge according to an exemplary embodiment.

### DETAILED DESCRIPTION

Hereinafter, exemplary embodiments according to the disclosure will be described. These descriptions and Examples are examples of the exemplary embodiments and do not limit the scope of the disclosure.

In the exemplary embodiments, numerical ranges described in the form of “a value ‘to’ a value” include the values as the minimum value and the maximum value.

In the exemplary embodiments, of numerical ranges described in series, the upper limit value or the lower limit value of one of the numerical ranges may be replaced by the upper limit value or the lower limit value of another one of the numerical ranges. For numerical ranges described in the exemplary embodiments, the upper limit values or the lower limit values of the numerical ranges may be replaced by values described in Examples.

In the exemplary embodiments, the term “step” includes not only an independent step, but also a step that is not clearly distinguished from another step as long as the intended object of the step is achieved.

In the exemplary embodiments, when exemplary embodiments are described with reference to drawings, the configurations of the exemplary embodiments are not limited to the configurations illustrated in the drawings. The drawings illustrate members in conceptual sizes and the relative relations between the sizes of the members are not limited to those in the drawings.

In the exemplary embodiments, components may each include plural substances belonging to such a component. In the exemplary embodiments, when the amounts of components of compositions are described and such a composition includes plural substances belonging to such a component, such an amount means the total amount of the plural substances in the composition unless otherwise specified.

In the exemplary embodiments, “(meth)acrylic” means that it may be “acrylic” or “methacrylic”.

In the exemplary embodiments, “electrostatic image developing white toner” may also be simply referred to as “white toner”, “electrostatic image developing color toner” may also be simply referred to as “color toner”, “electrostatic image white developer” may also be simply referred to as “white developer”, and “electrostatic image color developer” may also be simply referred to as “color developer”.

In the exemplary embodiments, “electrostatic image developing toner set” may also be simply referred to as “toner set”, and “electrostatic image developer set” may also be simply referred to as “developer set”.

### Electrostatic Image Developing White Toner

A white toner according to an exemplary embodiment includes white toner particles including a binder resin and a white coloring agent, an external additive including poly(meth)acrylate particles.

In the white toner according to the exemplary embodiment, the white toner particles have a volume-average particle size D_{50W} of 6.0 μm or more and 10 μm or less.

The ratio of the white toner particles having a particle size of 3.2 μm or less relative to all the white toner particles is 0.5 vol % or more and 3 vol % or less.

The white toner particles have a specific surface area S_{W} of 0.7 cm²/g or more and 1.2 cm²/g or less.

The external addition amount of the poly(meth)acrylate particles relative to the white toner particles is 0.1 mass % or more and 2.0 mass % or less.

The white toner according to the exemplary embodiment, which have the above-described features, may provide, even in repeated formation of low-area-coverage images, white images in which lowering of the whiteness is suppressed. The reasons for this are inferred as follows.

In the related art, in formation of color images on color recording media or permeable recording media, in order to suppress degradation of coloration of the color images, white toners are known to be used to form white images as underlying layers.

Such a white toner contains a large amount of a conductive white coloring agent having a high specific gravity and represented by titanium oxide, for example. Thus, from the viewpoint of having a high charge injection ability and having a high probability of, during injection of the transfer electric field, reverse of the charge polarity of the toner, and from the viewpoint of having a high probability of embedding of the external additive, the white toner tends to undergo degradation of the transferability.

In addition, in the case of forming color images on white recording media, white images serving as underlying layers are not formed or low-area-coverage white images are often repeatedly formed, and hence the white toner is scarcely consumed. In this case, in the white developer developing device, the white toner is continuously subjected to the stirring load for a long time, and the external additive is embedded in the white toner particles, which results in degradation of the transferability. Furthermore, in the surfaces of the white toner particles, the white coloring agent is exposed to serve as charge injection sites, so that, during injection of the transfer electric field, reverse of the charge polarity of the toner occurs, which results in degradation of the transferability.

In such a state, when an image in which a white image serving as an underlying layer is formed using the white toner and a color image is formed on the white image is transferred, the transferability is degraded and a white image having a low whiteness (namely, the degree of hiding) is formed.

Thus, in the white toner according to the exemplary embodiment, to the white toner particles having a specific surface area S_{w} of 0.7 cm²/g or more and 1.2 cm²/g or less and a volume-average particle size D_{50W} of 6.0 μm or more and 10 μm or less in which the ratio of the white toner particles having a particle size of 3.2 μm or less is 0.5 vol % or more and 3 vol % or less, poly(meth)acrylate particles are externally added in an external addition amount of 0.1 mass % or more and 2.0 mass % or less.

The poly(meth)acrylate particles serving as an external additive have an insulating property and hence may function as physical spacers and may also function as charge injection blocking sites. This may reduce the non-electrostatic adhesion and charge injection ability of the white toner particles. This may reduce the probability of, during injection of the transfer electric field, occurrence of reverse of the charge polarity of the toner.

In particular, the volume-average particle size of the white toner particles is set to the above-described range, so that the poly(meth)acrylate particles may be likely to adhere to the white toner particles and the poly(meth)acrylate particles may function as physical spacers and may also function as charge injection blocking sites.

In addition, the white toner particles having the above-described specific surface area have a large number of fine irregularities, so that, even when the poly(meth)acrylate particles move to recessed portions of the white toner particles, the poly(meth)acrylate particles may not have the chance of collision to the surrounding white toner particles or carriers, and may be less likely to move from the recessed portions. Thus, even poly(meth)acrylate particles having relatively large particle sizes in the external additive (in other words, having a low van der Waals force) and having a low non-electrostatic adhesion may be kept in the state of adhering to the white toner particles. Thus, even when the poly(meth)acrylate particles are present in the recessed portions, the function of the charge injection blocking sites may be maintained.

Even when the poly(meth)acrylate particles are present in the protruding portions of the white toner particles, the poly(meth)acrylate particles having relatively large particle sizes in the external additive may be less likely to be embedded in the white toner particles and the function of the spacers may be maintained.

In addition, the ratio of the fine white toner particles having a high van der Waals force and having a particle size of 3.2 μm or less is set to the above-described range, so that the poly(meth)acrylate particles may be more likely to adhere to the white toner particles, and the poly(meth)acrylate particles may function as physical spacers and may also function as charge injection blocking sites.

For the above-described reasons, the white toner according to the exemplary embodiment may inferentially provide, even in repeated formation of low-area-coverage images, white images in which lowering of the whiteness is suppressed.

Hereinafter, the white toner according to the exemplary embodiment will be described in detail.

The white toner according to the exemplary embodiment includes white toner particles and an external additive including poly(meth)acrylate particles. Note that elements of the white toner particles will be described later.

### Volume-Average Particle Size D_{50W} of White Toner Particles

The white toner particles have a volume-average particle size D_{50W} of 6.0 μm or more and 10 μm or less. The white toner particles have a volume-average particle size D_{50W} of preferably 6.3 μm or more and 9.5 μm or less, more preferably 6.5 μm or more and 9.0 μm or less. The volume-average particle size D_{50W} of the white toner particles is the volume-average particle size of all the white toner particles.

When the volume-average particle size D_{50W} of the white toner particles is set to such a range, the white toner particles may have an appropriate particle size and the poly(meth)acrylate particles may become likely to adhere to the white toner particles. Thus, the poly(meth)acrylate particles may function as physical spacers and may also function as charge injection blocking sites, and white images in which lowering of the whiteness is suppressed may be provided.

The volume-average particle size D_{50W} of the white toner particles is measured in the following manner.

The volume-average particle size D_{50W} of the white toner particles is measured using a Coulter Multisizer II (manufactured by Beckman Coulter, Inc.) and an electrolyte ISOTON-II (manufactured by Beckman Coulter, Inc.). In the measurement, to 2 ml of a 5 mass % aqueous solution of a surfactant (preferably sodium alkylbenzene sulfonate), 0.5 mg or more and 50 mg or less of a measurement sample is added, and this is added to 100 ml or more and 150 ml or less of the electrolyte. The electrolyte in which the sample is suspended is subjected to, using an ultrasonic dispersing machine, a dispersing treatment for 1 minute, and subjected to, using a Coulter Multisizer II and an aperture having an aperture diameter of 100 μm, measurement of particle sizes of particles having particle sizes in the range of 2 μm or more and 60 μm or less. The number of samples measured (namely, the number of particles) is 50,000. In the volume-based particle size distribution of the measured particle sizes, the particle size corresponding to a cumulative value of 50% counted from the smaller particle size is determined as the volume-average particle size D_{50W} of the white toner particles.

Note that, when properties of toner particles of a toner are measured and the toner includes the toner particles and an external additive, the toner and a mixture solution of ion-exchanged water and a surfactant may be subjected to an ultrasonic treatment for 20 minutes to remove the external additive; removal of the surfactant and drying and collection of the toner particles may be followed by the measurement. Note that the removal treatment for the external additive may be repeated until removal of the external additive is achieved.

### Ratio of White Toner Particles Having Particle Size of 3.2 μm or Less

The ratio of the white toner particles having a particle size of 3.2 μm or less relative to all the white toner particles is 0.5 vol % or more and 3 vol % or less. The ratio of the white toner particles having a particle size of 3.2 μm or less is preferably 0.55 vol % or more and 2.7 vol % or less, more preferably 0.6 vol % or more and 2.5 vol % or less.

When the ratio of the white toner particles having a particle size of 3.2 μm or less is set to such a range, the number of white toner particles having a high van der Waals force may be increased and furthermore the poly(meth)acrylate particles may become likely to adhere to the white toner particles. Thus, the poly(meth)acrylate particles may function as physical spacers and may also function as charge injection blocking sites, and white images in which lowering of the whiteness is suppressed may be provided.

The ratio of the white toner particles having a particle size of 3.2 μm or less may be adjusted by, in the case of the aggregation-coalescence method, for example, control of the temperature increase rate during aggregation of the resin particles. Alternatively, in the case of the kneading-pulverization method, the ratio of the white toner particles having a particle size of 3.2 μm or less may be adjusted by, for example, classification using a well-known centrifugal classifier, inertial classifier, or the like to remove fine particles (particles smaller than the target particle size range) and rough particles (particles larger than the target particle size range).

The ratio of the white toner particles having a particle size of 3.2 μm or less is measured in the following manner.

The volume-average particle size D_{50W} of the white toner particles is measured; in the volume-based particle size distribution of the determined particle sizes, the volume ratio of white toner particles having a particle size of 3.2 μm or less is determined.

Specific surface area S_{W} of white toner particles

The white toner particles have a specific surface area S_{W} of 0.7 cm²/g or more and 1.2 cm²/g or less. The white toner particles have a specific surface area S_{W} of preferably 0.85 cm²/g or more and 1.2 cm²/g or less, more preferably 1 cm²/g or more and 1.2 cm²/g or less. The specific surface area S_{W} of the white toner particles is the specific surface area of all the white toner particles.

The specific surface area S_{W} of the white toner particles is set to such a range, so that, as described above, the white toner particles may function, in the recessed or protruding portions in the surfaces, as physical spacers and also as charge injection blocking sites, and white images in which lowering of the whiteness is suppressed may be provided.

The specific surface area S_{W} of the white toner particles may be adjusted by, in the case of the aggregation-coalescence method, for example, control of the pH during fusion-coalescence of the aggregate particles. Alternatively, for example, in the case of the kneading-pulverization method, the specific surface area S_{W} of the white toner particles may be adjusted by thermal storage in which the temperature and the time are controlled.

The specific surface area S_{W} of the white toner particles is a value measured by the BET method (namely, BET specific surface area) and is measured in the following manner.

The value is measured using a measurement apparatus that is a BET specific surface area analyzer (SA3100, manufactured by Beckman Coulter, Inc.) by the nitrogen displacement method. Specifically, 1 g of a measurement sample is accurately weighed out, placed into a sample tube, and subsequently subjected to a degassing treatment and to automatic measurement using the multipoint method; the resultant value is defined as the specific surface area (m²/g).

Note that, when the toner particles serving as the measurement target are a toner in which an external additive is externally added to the surfaces of the toner particles, the toner may be subjected to, together with a mixture solution of ion-exchanged water and a surfactant, an ultrasonic treatment for 20 minutes to remove the external additive, and removal of the surfactant and drying of the toner particles may be followed by the measurement. The removal treatment for the external additive may be repeated until removal of the external additive is achieved.

### Average Circularity of White Toner Particles

The relation between the average circularity R_{W} of the white toner particles and the average circularity R_{W3.2} of the white toner particles having a particle size of 3.2 μm or less preferably satisfies the relation of R_{W3.2}<R_{W}, more preferably satisfies the relation of 0.05<R_{W}-R_{W3.2}<0.1, still more preferably satisfies the relation of 0.07<R_{W}-R_{W3.2}<0.1. The average circularity R_{W} of the white toner particles is the average circularity of all the white toner particles.

When the relation between the average circularity R_{W} of the white toner particles and the average circularity R_{W3.2} of the white toner particles having a particle size of 3.2 μm or less satisfies such a relation, the poly(meth)acrylate particles may selectively adhere to the white toner particles having a particle size of 3.2 μm or less and may improve the transferability of the white toner having a particle size of 3.2 μm or less, which has low transferability. Thus, white images in which lowering of the whiteness is further suppressed may be provided.

From the viewpoint of improving the hiding ability and improving the whiteness, the average circularity R_{W} of the white toner particles is preferably 0.93 or more and 0.98 or less, more preferably 0.95 or more and 0.97 or less.

The average circularity R_{W} of the white toner particles may be adjusted by, in the case of the aggregation-coalescence method, for example, control of the fusion-coalescence temperature of the aggregate particles, the fusion-coalescence end time of the aggregate particles, or the pH during fusion-coalescence of the aggregate particles. The average circularity R_{W} of the white toner particles may also be adjusted by, for example, in the pulverization step of the white toner, control of pulverization conditions (such as the temperature and the rotation rate).

The average circularity R_{W3.2} of the white toner particles having a particle size of 3.2 μm or less may be adjusted by, in the case of the aggregation-coalescence method, for example, control of the temperature increase rate during aggregation of resin particles and fusion-coalescence conditions of the aggregate particles. Alternatively, in the case of the kneading-pulverization method, the average circularity R_{W3.2} of the white toner particles having a particle size of 3.2 μm or less may be adjusted by, for example, after a classification step, performing an additional pulverization step of fine powder particles and mixing the fine powder particles with the particles having a median particle size.

The average circularity R_{W} of the white toner particles and the average circularity R_{W3.2} of the white toner particles having a particle size of 3.2 μm or less are measured in the following manner.

The average circularity of the white toner particles is determined as equivalent circular circumference/circumference (specifically, the circumference of a circle having the same projection area as the particle image/the circumference of the particle projection image).

Specifically, the average circularity is a value measured in the following manner.

First, white toner particles to be measured are sampled by suctioning and caused to form a flat flow; a stroboscope is caused to flash momentarily to obtain, as a still picture, the image of particles, and the image of particles is subjected to image analysis using a flow particle image analyzer (manufactured by SYSMEX CORPORATION, FPIA-3000). The number of samples (in other words, the number of particles) used for determining the average circularity is 3,500.

The determined average circularity is defined as the average circularity R_{W} of the white toner particles.

On the other hand, the average circularity R_{W3.2} of the white toner particles having a particle size of 3.2 μm or less is determined in the following manner: the volume-based particle size data is extracted from the data of the 3500 particles obtained in the above-described manner, and the circularity data of particles having a volume-based particle size of 3.2 μm or less is averaged.

### Elements of White Toner Particles

The white toner particles include a binder resin and a white coloring agent and include, as needed, a release agent and another additive.

### Binder Resin

Examples of the binder resin include homopolymers of monomers such as styrenes (such as styrene, p-chlorostyrene, and α-methylstyrene), (meth)acrylic esters (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), or olefins (such as ethylene, propylene, and butadiene), and vinyl-based resins of copolymers that are combinations of two or more of such monomer species.

Examples of the binder resin include non-vinyl-based resins such as epoxy resins, polyester resins, polyurethane resins, polyamide resins, cellulose resins, polyether resins, and modified rosins, mixtures of the foregoing and the above-described vinyl-based resins, and graft polymers prepared by polymerizing, in the presence of the foregoing, vinyl-based monomers.

Such binder resins may be used alone or in combination of two or more thereof.

The binder resin may be a styrene acrylic resin or a polyester resin, or may be a hybrid resin including a polyester resin unit and a styrene acrylic resin unit.

### (1) Styrene Acrylic Resin

The styrene acrylic resin that may serve as the binder resin is a copolymer prepared by copolymerization of at least a styrene-based monomer (a monomer having a styrene skeleton) and a (meth)acrylic monomer (a monomer including a (meth)acryloyl group, preferably a monomer including a (meth)acryloyloxy group). Examples of the styrene acrylic resin include copolymers of a monomer of styrenes and a monomer of the above-described (meth)acrylates. Note that, in the styrene acrylic resin, the acrylic resin moiety is an acrylic monomer or a methacrylic monomer, or a moiety provided by polymerization the foregoing. The term “(meth)acrylic” includes “acrylic” and “methacrylic”.

Specific examples of the styrene-based monomer include styrene, alkyl-substituted styrenes (such as α-methylstyrene, 2-methylstyrene, 3-methylstyrene, 4-methylstyrene, 2-ethylstyrene, 3-ethylstyrene, and 4-ethylstyrene), halogen-substituted styrenes (such as 2-chlorostyrene, 3-chlorostyrene, and 4-chlorostyrene), and vinylnaphthalene. Such styrene-based monomers may be used alone or in combination of two or more thereof.

Of these, the styrene-based monomer is, from the viewpoint of high reactivity, ease of control of the reaction, and availability, preferably styrene.

Specific examples of the (meth)acrylic monomer include (meth)acrylic acid and (meth)acrylic esters. Examples of the (meth)acrylic esters include (meth)acrylic alkyl esters (such as methyl (meth)acrylate, ethyl (meth)acrylate, n-propyl (meth)acrylate, n-butyl (meth)acrylate, n-pentyl (meth)acrylate, n-hexylacrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), (meth)acrylic aryl esters (such as phenyl (meth)acrylate, biphenyl (meth)acrylate, diphenylethyl (meth)acrylate, t-butylphenyl (meth)acrylate, and terphenyl (meth)acrylate), dimethylaminoethyl (meth)acrylate, diethylaminoethyl (meth)acrylate, methoxyethyl (meth)acrylate, 2-hydroxyethyl (meth)acrylate, P-carboxyethyl (meth)acrylate, and (meth)acrylamide. Such (meth)acrylic monomers may be used alone or in combination of two or more thereof.

Note that, of the (meth)acrylic monomers, of the (meth)acrylic esters, from the viewpoint of improving the fixability of the toner, preferred are (meth)acrylic esters including alkyl groups having 2 or more and 14 or less carbon atoms (preferably 2 or more and 10 or less, more preferably 3 or more and 8 or less carbon atoms). In particular, preferred is n-butyl (meth)acrylate, and particularly preferred is n-butyl acrylate.

The copolymerization ratio of the styrene-based monomer and the (meth)acrylic monomer (based on mass, styrene-based monomer/(meth)acrylic monomer) is not particularly limited and may be 85/15 to 60/40.

The styrene acrylic resin may have a crosslinked structure. Examples of the styrene acrylic resin having a crosslinked structure include copolymers prepared by copolymerization of at least a styrene-based monomer, a (meth)acrylic monomer, and a crosslinkable monomer.

Examples of the crosslinkable monomer include bi- or higher functional crosslinking agents.

Examples of bifunctional crosslinking agents include divinylbenzene, divinylnaphthalene, di(meth)acrylate compounds (such as diethylene glycol di(meth)acrylate, methylenebis(meth)acrylamide, decanediol diacrylate, and glycidyl (meth)acrylate), polyester-type di(meth)acrylates, and 2-([1′-methylpropylideneamino]carboxyamino)ethyl methacrylate.

Examples of tri- or higher functional crosslinking agents include tri(meth)acrylate compounds (such as pentaerythritol tri(meth)acrylate, trimethylolethane tri(meth)acrylate, and trimethylolpropane tri(meth)acrylate), tetra(meth)acrylate compounds (such as pentaerythritol tetra(meth)acrylate and oligoester (meth)acrylates), 2,2-bis(4-methacryloxy, polyethoxy phenyl)propane, diallyl phthalate, triallyl cyanurate, triallyl isocyanurate, triallyl trimellitate, and diallyl chlorendate.

Of these, the crosslinkable monomer is, from the viewpoint of improving the fixability of the toner, preferably bi- or higher functional (meth)acrylate compounds, more preferably bifunctional (meth)acrylate compounds, still more preferably bifunctional (meth)acrylate compounds including an alkylene group having 6 to 20 carbon atoms, particularly preferably bifunctional (meth)acrylate compounds including a linear alkylene group having 6 to 20 carbon atoms.

The copolymerization ratio of the crosslinkable monomer to all the monomers (based on mass, crosslinkable monomer/all the monomers) is not particularly limited and may be 2/1,000 to 20/1,000.

The styrene acrylic resin has a glass transition temperature (Tg) of, from the viewpoint of improving the fixability of the toner, preferably 40° C. or more and 75° C. or less, more preferably 50° C. or more and 65° C. or less.

The glass transition temperature of a resin is determined in a differential scanning calorimetry (DSC) curve provided by DSC. More specifically, the glass transition temperature of a resin is determined in accordance with “Extrapolated glass transition onset temperature” described in “How to determine glass transition temperature” in JIS K 7121:1987 “Testing methods for transition temperatures of plastics”.

The styrene acrylic resin has a weight-average molecular weight of, from the viewpoint of storage stability of the toner, preferably 5,000 or more and 200,000 or less, more preferably 10,000 or more and 100,000 or less, particularly preferably 20,000 or more and 80,000 or less.

The weight-average molecular weight and number-average molecular weight of a resin are measured by gel permeation chromatography (GPC). The measurement of the molecular weights by GPC is performed using, as a measurement instrument, a GPCHLC-8120GPC manufactured by Tosoh Corporation, a column TSKgel SuperHM-M (15 cm) manufactured by Tosoh Corporation, and a THF solvent. The weight-average molecular weight and number-average molecular weight are calculated using a molecular weight calibration curve created, on the basis of the measurement results, using monodisperse polystyrene standard samples.

The method for preparing the styrene acrylic resin is not particularly limited and various polymerization methods (such as solution polymerization, precipitation polymerization, suspension polymerization, bulk polymerization, and emulsion polymerization) may be used. For the polymerization reaction, publicly known operations (such as the batch operation, the semi-continuous operation, and the continuous operation) may be used.

### (2) Polyester Resin

The polyester resin may be, for example, a polycondensate of a polycarboxylic acid and a polyhydric alcohol.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (such as cyclohexane dicarboxylic acid), aromatic dicarboxylic acids (such as terephthalic acid, isophthalic acid, phthalic acid, and naphthalenedicarboxylic acid), anhydrides of the foregoing, and lower (for example, 1 or more and 5 or less carbon atoms) alkyl esters of the foregoing. Of these, the polycarboxylic acid is preferably, for example, aromatic dicarboxylic acids.

As the polycarboxylic acid, a dicarboxylic acid may be used in combination with a tri- or higher carboxylic acid having a crosslinkable structure or a branched structure. Examples of the tri- or higher carboxylic acid include trimellitic acid, pyromellitic acid, anhydrides of the foregoing, and lower (such as 1 or more and 5 or less carbon atoms) alkyl esters of the foregoing.

Such polycarboxylic acids may be used alone or in combination of two or more thereof.

Examples of the polyhydric alcohol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as ethylene oxide adduct of bisphenol A and propylene oxide adduct of bisphenol A). Of these, the polyhydric alcohol is, for example, preferably aromatic diols and alicyclic diols, more preferably aromatic diols.

As the polyhydric alcohol, a diol may be used in combination with a tri- or higher polyhydric alcohol having a crosslinkable structure or a branched structure. Examples of the tri- or higher polyhydric alcohol include glycerol, trimethylolpropane, and pentaerythritol.

Such polyhydric alcohols may be used alone or in combination of two or more thereof.

The polyester resin has a glass transition temperature (Tg) of preferably 50° C. or more and 80° C. or less, more preferably 50° C. or more and 65° C. or less.

The polyester resin has a weight-average molecular weight (Mw) of preferably 5000 or more and 1000000 or less, more preferably 7000 or more and 500000 or less. The polyester resin has a number-average molecular weight (Mn) of preferably 2000 or more and 100000 or less. The polyester resin has a polydispersity index Mw/Mn of preferably 1.5 or more and 100 or less, more preferably 2 or more and 60 or less.

The polyester resin may be prepared by publicly known production methods. Specifically, for example, the polyester resin is obtained by a method in which the polymerization temperature is set to 180° C. or more and 230° C. or less, the reaction system is brought to a reduced pressure as needed, and the reaction is caused while water or alcohol generated during condensation is removed.

When starting monomers do not dissolve or form a homogeneous mixture at the reaction temperature, a solvent having a high boiling point may be added as a solubilizing agent to achieve dissolution. In this case, the polycondensation reaction is caused while the solubilizing agent is distilled off. When there is a monomer having low compatibility, the monomer having low compatibility and an acid or alcohol to be polycondensed with the monomer may be condensed in advance and subsequently polycondensed with the main component.

The binder resin content relative to all the toner particles is preferably 40 mass % or more and 95 mass % or less, more preferably 50 mass % or more and 90 mass % or less, still more preferably 60 mass % or more and 85 mass % or less.

### White Coloring Agent

Examples of the white coloring agent include inorganic pigments and organic pigments.

Specific examples of the white coloring agent include inorganic pigments such as heavy calcium carbonate, light calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, and smectite, and organic pigments such as polystyrene resin particles and urea formalin resin particles.

Of these, from the viewpoint of forming white images having a higher hiding ability and providing better coloration of color images, the white coloring agent is preferably at least one selected from the group consisting of titanium oxide, silicon dioxide, aluminum oxide, zinc oxide, and zirconium oxide.

In particular, the white coloring agent is, from the viewpoint of having a high hiding ability, preferably titanium oxide. The titanium oxide may have a crystalline structure of anatase, rutile, or brookite.

The white coloring agent may be a surface-treated white coloring agent as needed or may be used in combination with a dispersing agent.

The white coloring agent has a volume-average particle size of, from the viewpoint of having a high hiding ability, preferably 150 nm or more and 900 nm or less, more preferably 180 nm or more and 800 nm or less, still more preferably 200 nm or more and 700 nm or less.

The volume-average particle size of the white coloring agent may be calculated in the following manner: a scanning electron microscope SEM (Scanning Electron Microscope) apparatus (manufactured by Hitachi, Ltd.: S-4100) is used to observe the white coloring agent and capture an image of the white coloring agent; this image is imported into an image analyzer (LUZEXIII, manufactured by NIRECO CORPORATION) and subjected to image analysis. Specifically, the area of each particle is measured and, from this area value, the equivalent circle diameter is calculated. In the volume-based cumulative frequency distribution of such calculated equivalent circle diameters, the 50% diameter (D50) is defined as the volume-average particle size of the white coloring agent. Note that, for the electron microscope, the magnification is controlled such that 10 or more and 50 or less particles of the white coloring agent appear in a field of view; plural fields of view are observed to collectively determine the equivalent circle diameters of primary particles.

Such white coloring agents may be used alone or in combination of two or more thereof.

The white coloring agent content relative to all the toner particles is preferably 15 mass % or more and 45 mass % or less, more preferably 20 mass % or more and 40 mass % or less.

### Release Agent

Examples of the release agent include hydrocarbon waxes; natural waxes such as carnauba wax, rice wax, and candelilla wax; mineral or petroleum waxes such as montan wax; and ester waxes such as fatty acid esters and montanic esters. The release agent is not limited to these.

The release agent has a melting temperature of preferably 50° C. or more and 110° C. or less, more preferably 60° C. or more and 100° C. or less. The melting temperature of the release agent is determined, in a differential scanning calorimetry (DSC) curve obtained by DSC, in accordance with “Melting peak temperature” in “How to determine melting temperature” in JIS K 7121:1987 “Testing methods for transition temperatures of plastics”.

The release agent content relative to all the toner particles is preferably 1 mass % or more and 20 mass % or less, more preferably 5 mass % or more and 15 mass % or less.

### Other Additive

Examples of the other additive include publicly known additives such as magnetic substances, charge control agents, and inorganic powders. Such additives are included, as internal additives, in the toner particles.

### Properties of White Toner Particles

The toner particles may be toner particles having a monolayer structure or may be toner particles constituted by a core part (core particle) and a cover layer (shell layer) covering the core part and having, what is called, a core-shell structure. The toner particles having a core-shell structure are constituted by, for example, a core part including a binder resin and, as needed, for example, a coloring agent and a release agent, and a cover layer including a binder resin.

### External Additive

### Poly(Meth)Acrylate Particles

The external additive includes poly(meth)acrylate particles.

The external addition amount of the poly(meth)acrylate particles relative to the white toner particles is 0.1 mass % or more and 2.0 mass % or less. The external addition amount of the poly(meth)acrylate particles is more preferably 0.1 mass % or more and 1.6 mass % or less, still more preferably 0.1 mass % or more and 1.2 mass % or less.

The external addition amount of the poly(meth)acrylate particles is set to such a range, so that the poly(meth)acrylate particles may function as physical spacers and may also function as charge injection blocking sites and white images in which lowering of the whiteness is suppressed may be provided.

The poly(meth)acrylate particles may have a volume-average particle size of preferably 300 nm or more and 600 nm or less, more preferably 300 nm or more and 550 nm or less, still more preferably 300 nm or more and 500 nm or less.

The volume-average particle size of the poly(meth)acrylate particles is set to such a range, so that the poly(meth)acrylate particles may have higher adhesion to the white toner particles and may function as spacers, and white images in which lowering of the whiteness is further suppressed may be provided.

The volume-average particle size of the poly(meth)acrylate particles is measured in the following manner.

A scanning electron microscope (SEM) is used to observe the surface of a white toner particle at a magnification of 40,000; at least 200 poly(meth)acrylate particles on the periphery of the toner particle are observed and the image of the poly(meth)acrylate particles is analyzed using an image processing analysis software WinRoof (manufactured by MITANI CORPORATION), to determine equivalent circle diameters. For at least 200 particles, particle sizes (equivalent circle diameters) are measured; in the volume-based particle size distribution, the particle size corresponding to a cumulative value of 50% counted from the smaller diameter is determined as the volume-average particle size.

The poly(meth)acrylate particles are preferably (meth)acrylic alkyl ester particles. The number of carbon atoms of the alkyl group of the (meth)acrylic alkyl ester is preferably 1 to 6, more preferably 1 to 4.

From the viewpoint that the poly(meth)acrylate particles function as spacers and function as charge injection blocking sites to suppress lowering of the whiteness, the poly(meth)acrylate particles are preferably methyl (meth)acrylate, more preferably methyl methacrylate.

Note that the poly(meth)acrylate particles may be crosslinked poly(meth)acrylate particles.

### Silica Particles

The external additive may include silica particles having a volume-average particle size of 80 nm or more and 120 nm or less (preferably 82 nm or more and 118 nm or less) (hereafter, also referred to as specified silica particles).

The specified silica particles are present as an external additive in the surfaces of the white toner particles, so that embedding of the poly(meth)acrylate particles may be inferentially suppressed. In addition, the specified silica particles may be likely to move into recessed portions of the surfaces of the white toner particles, so that the spaces of the recessed portions of the white toner particles into which the poly(meth)acrylate particles move may be inferentially reduced and the poly(meth)acrylate particles may inferentially become likely to move to protruding portions of the surfaces of the white toner particles. Thus, the poly(meth)acrylate particles may function as physical spacers and may also function as charge injection blocking sites and white images in which lowering of the whiteness is further suppressed may be provided.

The relation between the volume-average particle size D_{50S} of the specified silica particles and the volume-average particle size D_{50PMMA} of the poly(meth)acrylate particles preferably satisfies the relation of 2.5<D_{50PMMA}/D_{50S}<7.5, more preferably satisfies the relation of 2.7<D_{50PMMA}/D_{50S}<7.2.

When the relation between the volume-average particle size D_{50S} of the specified silica particles and the volume-average particle size D_{50PMMA} of the poly(meth)acrylate particles satisfies such a relation, the specified silica particles may inferentially become likely to suppress embedding of the poly(meth)acrylate particles and to facilitate move of the poly(meth)acrylate particles to protruding portions of the surfaces of the white toner particles. For this reason, the poly(meth)acrylate particles may function as physical spacers and may function as charge injection blocking sites, and white images in which lowering of the whiteness is further suppressed may be provided.

The volume-average particle size D_{50S} of the specified silica particles is measured in the same manner as in the volume-average particle size D_{50PMMA} of the poly(meth)acrylate particles.

The external addition amount of the specified silica particles relative to the white toner particles is preferably 0.8 mass % or more and 3.0 mass % or less, more preferably 0.8 mass % or more and 2.0 mass % or less.

When the external addition amount of the specified silica particles is set to such a range, the specified silica particles may inferentially become likely to suppress embedding of the poly(meth)acrylate particles and to facilitate move of the poly(meth)acrylate particles to protruding portions of the surfaces of the white toner particles. Thus, the poly(meth)acrylate particles may function as physical spacers and may also function as charge injection blocking sites and white images in which lowering of the whiteness is further suppressed may be provided.

Examples of the specified silica particles include dry-process silica particles and wet-process silica particles.

Examples of the dry-process silica particles include the combustion-process silica (fumed silica) prepared by combustion of a silane compound and the vaporized-metal-combustion-process silica prepared by deflagration of a metallic silicon powder.

Examples of the wet-process silica particles include wet-process silica particles prepared by a neutralization reaction between sodium silicate and mineral acid (such as the precipitation-process silica particles synthesized and aggregated under alkaline conditions and the gel-process silica particles synthesized and aggregated under acidic conditions), colloidal silica particles prepared by alkalization and polymerization of acidic silicic acid (such as silica sol particles), and sol-gel-process silica particles prepared by hydrolysis of an organic silane compound (such as an alkoxysilane).

Of these, the silica particles are preferably sol-gel silica particles.

The surfaces of the specified silica particles may be hydrophobized. Examples of the hydrophobizing agent include publicly known organosilicon compounds including an alkyl group (such as a methyl group, an ethyl group, a propyl group, or a butyl group); specific examples include alkoxysilane compounds, siloxane compounds, and silazane compounds. Of these, the hydrophobizing agent is preferably silazane compounds, preferably hexamethyldisilazane. Such hydrophobizing agents may be used alone or in combination of two or more thereof.

Examples of the method for hydrophobizing the specified silica particles using a hydrophobizing agent include a method in which supercritical carbon dioxide is used to dissolve the hydrophobizing agent in supercritical carbon dioxide to cause the hydrophobizing agent to adhere to the surfaces of the silica particles; a method in which, in the air, a solution including the hydrophobizing agent and a solvent in which the hydrophobizing agent dissolves is applied (such as spraying or coating) to the surfaces of the silica particles, to cause the hydrophobizing agent to adhere to the surfaces of the silica particles; and a method in which, in the air, a solution including the hydrophobizing agent and a solvent in which the hydrophobizing agent dissolves is added to a silica particle dispersion liquid, and the mixture solution of the silica particle dispersion liquid and the solution is held and subsequently dried.

### Other External Additive

The external additive may include, in addition to the poly(meth)acrylate particles and the specified silica particles, another external additive.

Examples of the other external additive include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)n, Al₂O₃·2SiO₂, CaCO₃, MgCO₃, BaSO₄, or MgSO₄.

The surfaces of the inorganic particles serving as the other external additive may be hydrophobized. The hydrophobization treatment is performed by, for example, immersing the inorganic particles in the hydrophobizing agent. The hydrophobizing agent is not particularly limited and examples include silane-based coupling agents, silicone oil, titanate-based coupling agents, and aluminum-based coupling agents. These may be used alone or in combination of two or more thereof. The amount of the hydrophobizing agent is ordinarily, relative to 100 parts by mass of the inorganic particles, 1 part by mass or more and 10 parts by mass or less.

Other examples of the external additive include resin particles (resin particles of a polystyrene or melamine resin, for example) and cleaning active agents (for example, particles of metallic salts of higher fatty acids represented by zinc stearate or fluoropolymers).

### Method for Producing Toner

Hereinafter, a method for producing a toner according to an exemplary embodiment will be described. Note that the following method for producing a toner can be applied to white toners and color toners, and hence the toner will be simply referred to as “toner”.

The toner according to the exemplary embodiment is obtained by producing toner particles and subsequently externally adding, to the toner particles, an external additive.

The toner particles may be produced by a dry production method (such as the kneading-pulverization method) or a wet production method (such as the aggregation-coalescence method, the suspension-polymerization method, or the dissolution-suspension method). Such production methods are not particularly limited and publicly known production methods are employed. Of these, the aggregation-coalescence method may be used to produce the toner particles.

Specifically, for example, in the case of producing the toner particles by the aggregation-coalescence method,
a step of preparing a resin particle dispersion liquid in which resin particles serving as a binder resin are dispersed (resin-particle-dispersion-liquid preparation step), a step of aggregating, in the resin particle dispersion liquid (as needed, a dispersion liquid provided by mixing with another particle dispersion liquid), the resin particles (and, as needed, other particles), to form aggregate particles (aggregate particle formation step), and a step of heating the aggregate particle dispersion liquid in which the aggregate particles are dispersed, to fuse and coalesce the aggregate particles, to form toner particles (fusion-coalescence step) are performed, to produce toner particles.

Hereinafter, the steps of the aggregation-coalescence method will be described in detail. In the following descriptions, a method in which toner particles also including a release agent are produced will be described; however, the release agent is used as needed. Other additives other than the release agent may also be naturally used.

### Resin-Particle-Dispersion-Liquid Preparation Step

A resin particle dispersion liquid in which resin particles serving as a binder resin are dispersed, a white-coloring-agent-particle dispersion liquid in which a white coloring agent is dispersed, and a release agent particle dispersion liquid in which a release agent particles are dispersed are prepared.

The resin particle dispersion liquid is prepared by, for example, dispersing the resin particles, using a surfactant, in a dispersion medium.

Examples of the dispersion medium used for the resin particle dispersion liquid include aqueous media.

Examples of the aqueous media include waters such as distilled water and ion-exchanged water and alcohols. These may be used alone or in combination of two or more thereof.

Examples of the surfactant include anionic surfactants such as sulfuric acid ester salt-based, sulfonic acid salt-based, phosphoric acid ester-based, and soap-based surfactants; cationic surfactants such as amine salt-type and quaternary ammonium salt-type surfactants; and nonionic surfactants such as polyethylene glycol-based, alkylphenol ethylene oxide adduct-based, and polyhydric alcohol-based surfactants. Of these, in particular, anionic surfactants and cationic surfactants may be used. Such a nonionic surfactant may be used in combination with an anionic surfactant or a cationic surfactant.

Such surfactants may be used alone or in combination of two or more thereof.

Examples of the method of dispersing the resin particles in a dispersion medium include ordinary dispersing methods using a rotary-shearing homogenizer or a media-equipped ball mill, sand mill, or DYNO-MILL, for example. Alternatively, depending on the type of the resin particles, a phase inversion emulsification method may be performed to disperse the resin particles in a dispersion medium. The phase inversion emulsification method is a method of dissolving the resin to be dispersed, in a hydrophobic organic solvent in which the resin is soluble, adding a base to the organic continuous phase (O phase) to achieve neutralization, and subsequently adding water (W phase) to cause phase inversion from W/O to O/W, to achieve dispersing of the resin in the form of particles in the aqueous medium.

The resin particles dispersed in the resin particle dispersion liquid have a volume-average particle size of, for example, preferably 0.01 μm or more and 1 μm or less, more preferably 0.08 μm or more and 0.8 μm or less, still more preferably 0.1 μm or more and 0.6 μm or less.

For the volume-average particle size of the resin particles, a laser diffraction particle size distribution analyzer (such as LA-700 manufactured by HORIBA, Ltd.) is used for measurement to obtain a particle size distribution; the particle size distribution is divided into particle size ranges (channels); over these channels, a volume-based cumulative distribution curve is drawn from smaller to larger particle sizes; the particle size corresponding to a cumulative value of 50% relative to all the particles is defined as volume-average particle size D₅₀ᵥ. Similarly, the volume-average particle sizes of particles in other dispersion liquids are also measured.

The resin particle content of the resin particle dispersion liquid is preferably 5 mass % or more and 50 mass % or less, more preferably 10 mass % or more and 40 mass % or less.

As with the resin particle dispersion liquid, the release agent particle dispersion liquid is prepared. Specifically, for the resin particle dispersion liquid, the dispersion medium, the dispersing method, the volume-average particle size of the particles, and the particle content are the same as those of the release agent particle dispersion liquid.

As with the resin particle dispersion liquid, the white-coloring-agent-particle dispersion liquid is prepared. In the preparation of the white-coloring-agent-particle dispersion liquid, a dispersing apparatus having a high disintegration force may be used to round off the white coloring agent particles to prepare the white-coloring-agent-particle dispersion liquid.

In the white-coloring-agent-particle dispersion liquid, the white coloring agent particles have a volume-average particle size (measured using a laser diffraction particle size distribution analyzer) of preferably 200 nm or more and 900 nm or less, more preferably 250 nm or more and 800 nm or less, still more preferably 300 nm or more and 700 nm or less.

In the white-coloring-agent-particle dispersion liquid, the white coloring agent particle content is preferably 5 mass % or more and 50 mass % or less, more preferably 10 mass % or more and 40 mass % or less.

### Aggregate-Particle Formation Step

Subsequently, the resin particle dispersion liquid, the white-coloring-agent-particle dispersion liquid, and the release agent particle dispersion liquid are mixed together. Subsequently, in the mixed dispersion liquid, hetero-aggregation of the resin particles, the white coloring agent particles, and the release agent particles is caused to form aggregate particles having sizes close to the sizes of the target toner particles.

Specifically, for example, an aggregating agent is added to the mixed dispersion liquid and the mixed dispersion liquid is adjusted in terms of pH so as to be acidic (such as a pH of 2 or more and 5 or less), and a dispersion stabilizing agent is added as needed; subsequently, the mixed dispersion liquid is heated to a temperature close to the glass transition temperature of the resin particles (specifically, for example, a temperature of “the glass transition temperature of the resin particles—30° C.” or more and “the glass transition temperature—10° C.” or less), to aggregate the particles dispersed in the mixed dispersion liquid, to form the aggregate particles.

Alternatively, the aggregate-particle formation step may be performed in the following manner: for example, under stirring of the mixed dispersion liquid using a rotary-shearing homogenizer, the aggregating agent is added at room temperature (for example, 25° C.), the mixed dispersion liquid is adjusted in terms of pH so as to be acidic (such as a pH of 2 or more and 5 or less), and a dispersion stabilizing agent is added as needed; and, subsequently, the heating is performed.

Examples of the aggregating agent include surfactants having a polarity opposite to that of the surfactant included in the mixed dispersion liquid, inorganic metal salts, and di- or higher valent metal complexes. In the case of using, as the aggregating agent, a metal complex, the amount of the aggregating agent used may be reduced and charging characteristics may be improved.

In addition to the aggregating agent, an additive that forms a complex or a similar bond with the metal ion of the aggregating agent may be used. As this additive, a chelating agent may be used.

Examples of the inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of chelating agent added is, for example, relative to 100 parts by mass of the resin particles, preferably 0.01 parts by mass or more and 5.0 parts by mass or less, more preferably 0.1 parts by mass or more and less than 3.0 parts by mass.

### Fusion-Coalescence Step

Subsequently, the aggregate particle dispersion liquid in which the aggregate particles are dispersed is heated to, for example, the glass transition temperature or more of the resin particles (for example, not less than a temperature 10° C. to 30° C. higher than the glass transition temperature of the resin particles), to fuse and coalesce the aggregate particles, to form toner particles.

The above-described steps are performed to provide toner particles.

The following steps may be performed to produce toner particles: a step of, after the aggregate particle dispersion liquid in which aggregate particles are dispersed is obtained, mixing together the aggregate particle dispersion liquid and the resin particle dispersion liquid in which resin particles are dispersed, to cause aggregation such that the resin particles further adhere to the surfaces of the aggregate particles, to form second aggregate particles, and a step of heating the second aggregate particle dispersion liquid in which the second aggregate particles are dispersed, to fuse and coalesce the second aggregate particles, to form toner particles having a core-shell structure.

After completion of the fusion-coalescence step, the toner particles formed in the solution are subjected to publicly known steps including a washing step, a solid-liquid separation step, and a drying step to obtain dry toner particles. As the washing step, from the viewpoint of chargeability, displacement washing using ion-exchanged water may be sufficiently performed. As the solid-liquid separation step, from the viewpoint of productivity, for example, suction filtration or pressure filtration may be performed. As the drying step, from the viewpoint of productivity, for example, freeze drying, flash drying, fluidized-bed drying, or vibrating fluidized-bed drying may be performed.

The toner according to the exemplary embodiment is produced by, for example, adding and mixing an external additive with the obtained dry toner particles. The mixing may be performed using, for example, a V blender, a Henschel mixer, or a Loedige mixer. Furthermore, as needed, for example, a vibratory classifier or an air classifier may be used to remove coarse particles from the toner.

### Electrostatic Image Developing Toner Set

A toner set according to an exemplary embodiment includes the white toner according to the exemplary embodiment and a color toner including non-white color toner particles.

For the toner set according to the exemplary embodiment, the white toner according to the exemplary embodiment may have a high hiding ability and white images in which lowering of the whiteness is suppressed may be formed, so that color images formed from the color toner may have improved coloration.

In the toner set according to the exemplary embodiment, the color toner may include an external additive including poly(meth)acrylate particles.

The relation between the external addition amount M_{PMMA_W} of the poly(meth)acrylate particles of the white toner and the external addition amount M_{PMMA-C} of the poly(meth)acrylate particles of the color toner preferably satisfies the relation of M_{PMMA-C}<M_{PMMA-W}, more preferably satisfies the relation of 0.02 mass %<M_{PMMA-W}-M_{PMMA-C}<0.3 mass %.

Relative to the color toner, the white toner has large surface areas of the toner particles and the external addition amount of the poly(meth)acrylate particles is larger in the white toner than in the color toner. In addition, the white toner often has lower transferability than the color toner. Thus, in order that, in the white toner, the poly(meth)acrylate particles become more likely to function as spacers and to function as charge injection blocking sites, the relation between the external addition amount M_{PMMA_W} of the poly(meth)acrylate particles of the white toner and the external addition amount M_{PMMA_C} of the poly(meth)acrylate particles of the color toner may satisfy such a relation. As a result, degradation of coloration of color images formed from the color toner may be suppressed.

The relation between the average circularity SF_{W} of the white toner particles and the average circularity SF_{C} of the color toner particles preferably satisfies the relation of SF_{W}<SF_{C}, more preferably satisfies the relation of 0.02<SF_{C}-SF_{W}<0.04. The average circularity SF_{W} of the white toner particles has the same definition as the average circularity R_{W} of the white toner particles.

In the case of forming an image in which a color toner image is disposed on a white toner image, for example, a color toner layer serving as the lowermost layer and a white toner layer serving as the uppermost layer are formed on an intermediate transfer body. The transfer of plural toner layers is strongly affected by the transferability of the lowermost toner layer; thus, the more spherical the toner particles of the color toner layer, the higher the transferability of the image in which the color toner image is disposed on the white toner image. Thus, the relation between the average circularity SF_{W} of the white toner particles and the average circularity SF_{C} of the color toner particles may satisfy such a relation. As a result, degradation of coloration of the color image formed from the color toner may be suppressed.

In the toner set according to the exemplary embodiment, from the viewpoint of further improving the coloration of the color image, the volume-average particle size of the color toner particles may be smaller than the volume-average particle size of the white toner particles.

For the toner set according to the exemplary embodiment, from the viewpoint of further improving the coloration of the color image, the ratio of volume-average particle size of the white toner particles to the volume-average particle size of the color toner particles (the volume-average particle size of the white toner particles/the volume-average particle size of the color toner particles) is preferably 4/15 or more and 16/3 or less, more preferably 5/12 or more and 12/3.5 or less, still more preferably 6/10 or more and 10/4 or less.

The terms “color toner”, “color toner particles”, “colored coloring agent”, and “color image” refer to a toner, toner particles, a coloring agent, and an image that have a non-white color. Examples of the color toner include color toners of yellow (Y), magenta (M), cyan (C), or the like and a black (K) toner.

For the toner set according to the exemplary embodiment, a combination of toners of plural colors may be used as the color toners; for example, four color toners of a yellow toner, a magenta toner, a cyan toner, and a black toner may be used in combination with the white toner to provide a toner set. In this case, of the color toners, at least one color toner may satisfy the above-described conditions, and all the color toners used in combination with the white toner may satisfy the above-described conditions.

The color toner may be the same as the white toner except that, instead of the white coloring agent, a colored coloring agent is used; the color toner may have the same properties and examples as the white toner.

Examples of the colored coloring agent include various pigments such as carbon black, Chrome Yellow, Hansa yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Dupont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue chloride, Phthalocyanine Blue, Pigment Blue, Phthalocyanine Green, and Malachite Green Oxalate; and various dyes such as acridine-based, xanthene-based, azo-based, benzoquinone-based, azine-based, anthraquinone-based, thioindigo-based, dioxazine-based, thiazine-based, azomethine-based, indigo-based, phthalocyanine-based, aniline black-based, polymethine-based, triphenylmethane-based, diphenylmethane-based, and thiazole-based dyes.

Such colored coloring agents may be used alone or in combination of two or more thereof.

In the color toner particles, the colored coloring agent content is, for example, relative to all the color toner particles, preferably 1 mass % or more and 30 mass % or less, more preferably 3 mass % or more and 15 mass % or less.

### Electrostatic Image White Developer

A white developer according to an exemplary embodiment includes at least the white toner according to the exemplary embodiment, and may be a two-component developer that is a mixture of the white toner and a carrier.

Examples of the carrier include a covered carrier in which the surfaces of cores of a magnetic powder are covered with a resin; a magnetic powder dispersed carrier in which a magnetic powder is added so as to be dispersed in a matrix resin; and a resin impregnated carrier in which a porous magnetic powder is impregnated with a resin. Each of the magnetic powder dispersed carrier and the resin impregnated carrier may also be a carrier in which cores are the particles constituting the carrier and the surfaces of the cores are covered with a resin.

Examples of the material of the magnetic powder include magnetic metals such as iron, nickel, and cobalt and magnetic oxides such as ferrite and magnetite.

Examples of the cover resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins containing organosiloxane bonds or modified resins thereof, fluororesins, polyester, polycarbonate, phenolic resins, and epoxy resins. The cover resin and the matrix resin may contain additives such as conductive particles. The conductive particles may be particles of, for example, a metal such as gold, silver, or copper; carbon black, titanium oxide, zinc oxide, tin oxide, barium sulfate, aluminum borate, or potassium titanate.

The process of covering the surfaces of cores with a resin may be performed by, for example, dissolving the cover resin and various additives (used as needed) in an appropriate solvent to prepare a cover-layer-forming solution and by covering the surfaces of the cores with this solution. The solvent is not particularly limited and may be selected in accordance with, for example, the type of the resin used and the coatability. Specific examples of the covering process with a resin include an immersion process of immersing cores in the cover-layer-forming solution; a spraying process of spraying the cover-layer-forming solution to the surfaces of cores; a fluidized bed process of spraying the cover-layer-forming solution to cores being floated with fluidizing air; and a kneader-coater process of mixing, within a kneader-coater, the cores of a carrier and the cover-layer-forming solution and subsequently removing the solvent.

In the two-component developer, the mixing ratio (mass ratio) of the toner to the carrier is preferably toner:carrier=1:100 to 30:100, more preferably 3:100 to 20:100.

### Electrostatic Image Developer Set

A developer set according to an exemplary embodiment includes a white developer including the white toner of the toner set according to the exemplary embodiment and a color developer including the color toner of the toner set according to the exemplary embodiment.

In the developer set according to the exemplary embodiment, the white developer including the white toner according to the exemplary embodiment may form white images having a high hiding ability and providing good coloration of color images, so that color images formed from the color developer including the color toner may have improved coloration.

### Image Forming Apparatus and Image Forming Method

An image forming apparatus and an image forming method according to exemplary embodiments will be described.

The image forming apparatus according to the exemplary embodiment includes an image holding member, a charging section that charges the surface of the image holding member, an electrostatic image forming section that forms, on the charged surface of the image holding member, an electrostatic image, a development section that contains an electrostatic image developer and that develops, using the electrostatic image developer, the electrostatic image formed on the surface of the image holding member, to form a toner image, a transfer section that transfers, the toner image formed on the surface of the image holding member onto the surface of a recording medium, and a fixing section that fixes the toner image transferred onto the surface of the recording medium. As the electrostatic image developer, the electrostatic image white developer according to the exemplary embodiment is applied.

In the image forming apparatus according to the exemplary embodiment, an image forming method (the image forming method according to the exemplary embodiment) including the following steps is performed: a charging step of charging the surface of the image holding member; an electrostatic image formation step of forming, on the charged surface of the image holding member, an electrostatic image; a development step of developing, using the electrostatic image white developer according to the exemplary embodiment, the electrostatic image formed on the surface of the image holding member, to form a toner image; a transfer step of transferring the toner image formed on the surface of the image holding member onto the surface of a recording medium; and a fixing step of fixing the toner image transferred onto the surface of the recording medium.

As the image forming apparatus according to the exemplary embodiment, a publicly known image forming apparatus is applied such as a direct transfer mode apparatus that directly transfers a toner image formed on the surface of an image holding member onto a recording medium; an intermediate transfer mode apparatus that performs the first transfer of the toner image formed on the surface of the image holding member onto the surface of an intermediate transfer body, and that performs the second transfer of the transferred toner image on the surface of the intermediate transfer body onto the surface of a recording medium; an apparatus including a cleaning section that, after transfer of the toner image, cleans the surface (to be charged) of the image holding member; or an apparatus including a discharging section that, after transfer of the toner image, irradiates the surface (to be charged) of the image holding member with discharging light to achieve discharging.

When the image forming apparatus according to the exemplary embodiment is an intermediate transfer mode apparatus, the transfer section has, for example, a configuration including an intermediate transfer body on the surface of which the toner image is transferred, a first transfer section that performs the first transfer of the toner image formed on the surface of the image holding member onto the surface of the intermediate transfer body, and a second transfer section that performs the second transfer of the transferred toner image on the surface of the intermediate transfer body, onto the surface of a recording medium.

In the image forming apparatus according to the exemplary embodiment, for example, the part including the development section may have a cartridge structure (process cartridge) attachable to and detachable from the image forming apparatus. The process cartridge may be, for example, a process cartridge including a development section containing the electrostatic image developer according to the exemplary embodiment.

The image forming apparatus according to the exemplary embodiment may be a tandem system image forming apparatus in which an image forming unit that forms white toner images and at least one image forming unit that forms color toner images are disposed in parallel, or may be a single-color image forming apparatus that forms white images alone. In the latter case, on a recording medium, the image forming apparatus according to the exemplary embodiment forms a white image and another image forming apparatus forms a color image.

The recording medium on which an image is recorded using the image forming apparatus (image forming method) according to the exemplary embodiment is not particularly limited and publicly known recording media may be used. Examples include resin films or sheets and papers. Examples of applications of the resin films or sheets include packages, labels, packaging materials, advertising media, and OHP sheets.

Examples of the resin films or sheets include polyolefin resin films or sheets of polyethylene, polypropylene, or the like; polyester films or sheets of polyethylene terephthalate, polybutylene terephthalate, or the like; polyamide films or sheets of nylon or the like; and films or sheets of polycarbonate, polystyrene, modified polystyrene, polyvinyl chloride, polyvinyl alcohol, polylactic acid, or the like. These films or sheets may be unoriented films or sheets or uniaxially oriented or biaxially oriented films or sheets. The resin films or sheets may have a monolayer or multilayer form. The resin films or sheets may be films including a surface coat layer that aids fixing of toners or films or sheets having been subjected to a corona treatment, an ozone treatment, a plasma treatment, a flame treatment, or a glow discharge treatment, for example.

Examples of the order of stacking the recording medium, the color image, and the white image (hiding layer) include the following (a), (b), and (c).

Stacking order (a): in the direction away from the viewer, permeable recording medium/color image/white image (hiding layer)

Stacking order (b): in the direction away from the viewer, color image/permeable recording medium/white image (hiding layer)

Stacking order (c): in the direction away from the viewer, color image/white image (hiding layer)/recording medium (permeable or impermeable)

Hereinafter, a non-limiting example of the image forming apparatus according to the exemplary embodiment will be described. Note that some sections in the drawing will be described, but the other portions will not be described.

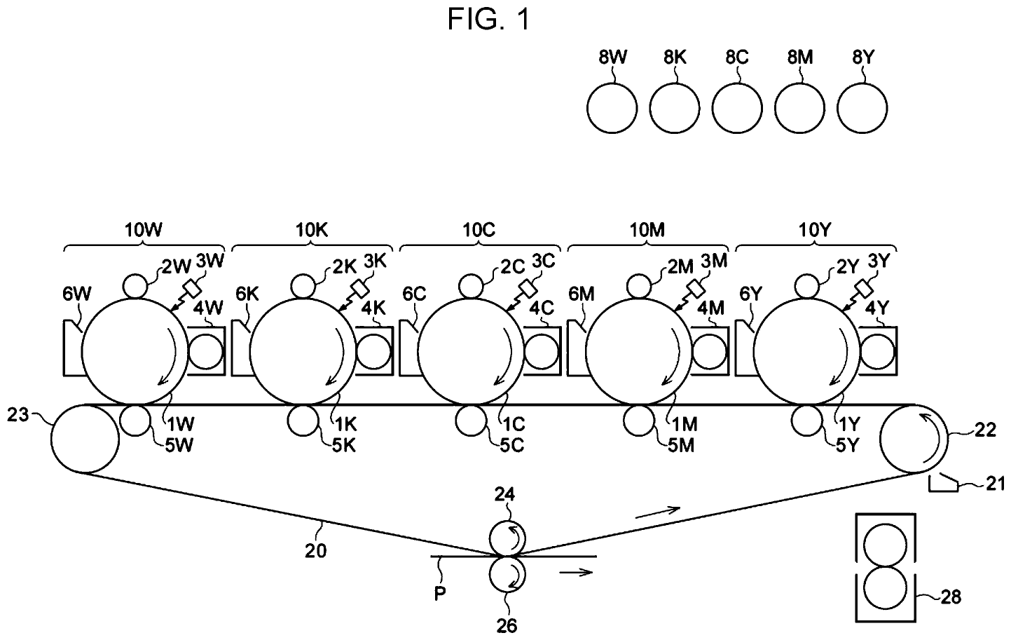

FIG. 1 is a schematic configuration view illustrating the image forming apparatus according to the exemplary embodiment, specifically illustrating a quintuplet-tandem-system, intermediate-transfer-mode image forming apparatus.

The image forming apparatus in FIG. 1 includes the electrophotographic-system first to fifth image formation units 10Y, 10M, 10C, 10K, and 10W (image formation sections) that output images of individual colors of yellow (Y), magenta (M), cyan (C), black (K), and white (W) on the basis of color-separation image data. These image formation units (hereafter, may also be simply referred to as “units”) 10Y, 10M, 10C, 10K, and 10W are arranged in parallel in the horizontal direction so as to be separated from each other at predetermined intervals. These units 10Y, 10M, 10C, 10K, and 10W may be process cartridges attachable to and detachable from the image forming apparatus.

In lower portions of the units 10Y, 10M, 10C, 10K, and 10W, an intermediate transfer belt (an example of the intermediate transfer body) 20 is disposed so as to extend through the units. The intermediate transfer belt 20 is disposed so as to be wrapped around a driving roller 22, a support roller 23, and a counter roller 24 (in contact with the inner surface of the intermediate transfer belt 20) so as to be run in a direction from the first unit 10Y to the fifth unit 10W. On the image-holding-surface side of the intermediate transfer belt 20, an intermediate-transfer-body cleaning device 21 is disposed so as to face the driving roller 22.

To developing devices (examples of the development sections) 4Y, 4M, 4C, 4K, and 4W of the units 10Y, 10M, 10C, 10K, and 10W, toners including yellow, magenta, cyan, black, and white toners contained in toner cartridges 8Y, 8M, 8C, 8K, and 8W are supplied.

The first to fifth units 10Y, 10M, 10C, 10K, and 10W have the same configuration, operations, and actions, and hence the first unit 10Y, which is disposed upstream in the running direction of the intermediate transfer belt and forms a yellow image, will be described as a representative.

The first unit 10Y includes a photoreceptor 1Y serving as an image holding member. Around the photoreceptor 1Y, the following are sequentially disposed: a charging roller (an example of the charging section) 2Y that charges the surface of the photoreceptor 1Y to a predetermined potential; an exposure device (an example of the electrostatic image forming section) 3Y that uses a laser beam on the basis of color-separation image signals to expose the charged surface to form an electrostatic image; a developing device (an example of the development section) 4Y that supplies the toner to the electrostatic image to develop the electrostatic image; a first transfer roller (an example of the first transfer section) 5Y that transfers the developed toner image onto the intermediate transfer belt 20; and a photoreceptor cleaning device (an example of the cleaning section) 6Y that removes, after the first transfer, the residual toner on the surface of the photoreceptor 1Y.

The first transfer roller 5Y is disposed inside of the intermediate transfer belt 20 and at a position so as to face the photoreceptor 1Y. To each of the first transfer rollers 5Y, 5M, 5C, 5K, and 5W of the units, bias power supplies (not shown) that apply first transfer biases are individually connected. Each bias power supply applies a transfer bias variable under control by a controller (not shown), to the first transfer roller.

Hereinafter, in the first unit 10Y, the operations of forming a yellow image will be described.

First, before the operations, the charging roller 2Y charges the surface of the photoreceptor 1Y to a potential of −600 V to −800 V.

The photoreceptor 1Y is formed by forming, on a conductive (for example, volume resistivity at 20° C.: 1×10⁻⁶ Ωcm or less) base body, a photosensitive layer. This photosensitive layer has properties of normally having high resistivity (resistivity of ordinary resin), but, upon irradiation with a laser beam, having laser-beam irradiation portions having a different resistivity. Thus, the charged surface of the photoreceptor 1Y is irradiated with the laser beam from the exposure device 3Y in accordance with the yellow image data transmitted from the controller (not shown). This forms an electrostatic image having the yellow image pattern on the surface of the photoreceptor 1Y.

The electrostatic image is an image formed on the surface of the photoreceptor 1Y by charging: the laser beam radiated from the exposure device 3Y causes a decrease in the resistivity of the irradiated portions of the photosensitive layer where charges flow out from the charged surface of the photoreceptor 1Y while charges of the portions not irradiated with the laser beam remain, which results in formation of, what is called, a negative latent image.

The electrostatic image formed on the photoreceptor 1Y is rotated together with running of the photoreceptor 1Y to the predetermined development position. At this development position, the electrostatic image on the photoreceptor 1Y is turned into a visual image as a toner image by the developing device 4Y.

The developing device 4Y contains, for example, an electrostatic image developer including at least a yellow toner and a carrier. The yellow toner is stirred within the developing device 4Y to thereby be frictionally charged, and is held on the developer roller (an example of the developer holding member) so as to have charges having the same polarity (negative polarity) as in the charges on the charged photoreceptor 1Y. While the surface of the photoreceptor 1Y passes over the developing device 4Y, the yellow toner electrostatically adheres to the discharged latent image portions on the surface of the photoreceptor 1Y, so that the latent image is developed with the yellow toner. The photoreceptor 1Y having the yellow toner image formed is continuously run at the predetermined speed, to convey the developed toner image on the photoreceptor 1Y to the predetermined first transfer position.

When the yellow toner image on the photoreceptor 1Y is conveyed to the first transfer position, a first transfer bias is applied to the first transfer roller 5Y, and an electrostatic force from the photoreceptor 1Y toward the first transfer roller 5Y affects the toner image, so that the toner image on the photoreceptor 1Y is transferred onto the intermediate transfer belt 20. The transfer bias applied at this time has a polarity (+) opposite to the polarity (−) of the toner, and is controlled to be, for example, +10 μA at the first unit 10Y by a controller (not shown).

On the other hand, the toner remaining on the photoreceptor 1Y is removed by the photoreceptor cleaning device 6Y and collected.

The first transfer biases applied to the first transfer rollers 5M, 5C, 5K, and 5W disposed in the second unit 10M and its downstream units are also controlled as in the first unit.

Thus, the intermediate transfer belt 20 onto which the yellow toner image has been transferred at the first unit 10Y is conveyed sequentially through the second to the fifth units 10M, 10C, 10K, and 10W, to perform multiple transfer of the toner images of the colors so as to be stacked.

The intermediate transfer belt 20 on which multiple transfer of the toner images of the five colors has been performed at the first to the fifth units reaches a second transfer unit constituted by the intermediate transfer belt 20, the counter roller 24 in contact with the inner surface of the intermediate transfer belt, and a second transfer roller (an example of the second transfer section) 26 disposed on the image-holding-surface side of the intermediate transfer belt 20. On the other hand, a recording paper (an example of the recording medium) P is fed at a predetermined timing by a feeding mechanism to the gap where the second transfer roller 26 and the intermediate transfer belt 20 are in contact with each other, and a second transfer bias is applied to the counter roller 24. The transfer bias applied at this time has a polarity (−) the same as the polarity (−) of the toner, and the electrostatic force from the intermediate transfer belt 20 toward the recording paper P affects the toner image, to transfer the toner image on the intermediate transfer belt 20 onto the recording paper P. The second transfer bias at this time is determined in response to the resistance of the second transfer unit detected by the resistance detection section (not shown), and controlled on the basis of voltage.

Subsequently, the recording paper P is sent into the press region (nip) of the pair of fixing rollers in the fixing device (an example of the fixing section) 28, so that the toner image is fixed on the recording paper P, to form a fixed image.

Examples of the recording paper P onto which the toner image is transferred include plain paper used for electrophotographic-system copying machines and printers, for example. Examples of the recording medium include, in addition to the recording paper P, OHP sheets.

In order to further improve the smoothness of the surface of the fixed image, the recording paper P may have a smooth surface and, for example, the coat paper provided by coating the surface of the plain paper with, for example, resin and the art paper for printing may be used.

The recording paper P on which the color image has been fixed is conveyed to the exit unit, and the series of the color image formation operations is completed.

### Process Cartridge and Toner Cartridge

A process cartridge according to an exemplary embodiment will be described.

The process cartridge according to the exemplary embodiment is a process cartridge that contains the electrostatic image white developer according to the exemplary embodiment, includes a development section that develops, using the electrostatic image white developer, an electrostatic image formed on the surface of an image holding member, to form a toner image, and is attachable to and detachable from an image forming apparatus.

The process cartridge according to the exemplary embodiment may have a configuration including the development section and, as needed, at least one other section selected from an image holding member, a charging section, an electrostatic image forming section, and a transfer section, for example.

Hereinafter, a non-limiting example of the process cartridge according to the exemplary embodiment will be described. In the following descriptions, some sections in the drawing will be described, but the other portions will not be described.

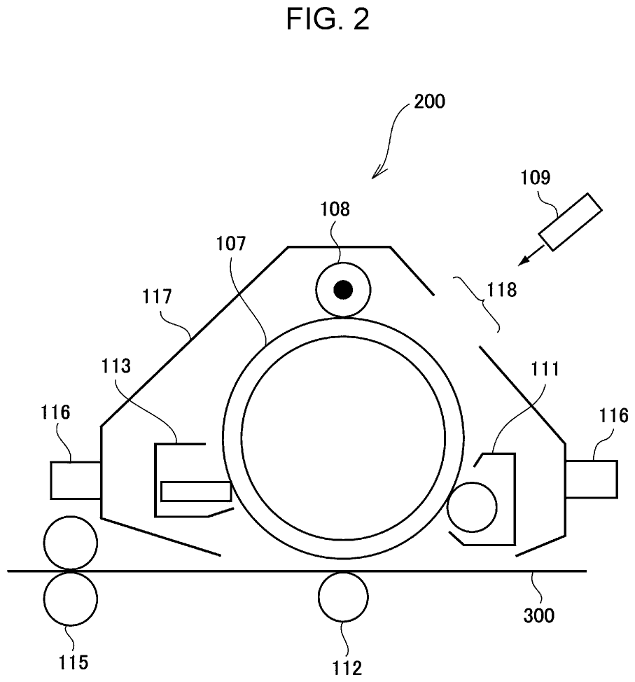

FIG. 2 is a schematic configuration view illustrating the process cartridge according to the exemplary embodiment.

In a process cartridge 200 in FIG. 2, for example, an attachment rail 116 and a housing 117 having an opening 118 for exposure to light are used to integrally combine and hold a photoreceptor 107 (an example of the image holding member) and a charging roller 108 (an example of the charging section), a developing device 111 (an example of the development section), and a photoreceptor cleaning device 113 (an example of the cleaning section) that are disposed around the photoreceptor 107, to provide a cartridge.

FIG. 2 illustrates an exposure device 109 (an example of the electrostatic image forming section), a transfer device 112 (an example of the transfer section), a fixing device 115 (an example of the fixing section), and a resin sheet 300 (an example of the recording medium).

Hereinafter, a toner cartridge according to an exemplary embodiment will be described.

The toner cartridge according to the exemplary embodiment is a toner cartridge containing the white toner according to the exemplary embodiment and is attachable to and detachable from an image forming apparatus. The toner cartridge contains a supplemental toner to be supplied to the development section disposed within the image forming apparatus.

The image forming apparatus illustrated in FIG. 1 is an image forming apparatus to or from which the toner cartridges 8W, 8K, 8C, 8M, and 8Y are attachable and detachable, and the developing devices 4W, 4K, 4C, 4M, and 4Y are connected to toner cartridges corresponding to the colors via toner supply pipes (not shown). When the toner contained in such a toner cartridge is nearly depleted, this toner cartridge is exchanged. An example of the toner cartridge according to the exemplary embodiment is the toner cartridge 8W in which the white toner according to the exemplary embodiment is contained. The toner cartridges 8K, 8C, 8M, and 8Y respectively contain toners of black, cyan, magenta, and yellow.

### EXAMPLES

Hereinafter, exemplary embodiment according to the disclosure will be described in detail with reference to Examples; however, the exemplary embodiments according to the disclosure are not limited to these Examples at all. In the following descriptions, “part” and “%” are based on mass unless otherwise specified.

Preparation of particle dispersion liquids etc.

### Preparation of White-Coloring-Agent-Particle Dispersion Liquid (1)

Titanium oxide particles (manufactured by Titan Kogyo, Ltd., product No. KR-380): 100 parts
Anionic surfactant (manufactured by DAI-ICHI KOGYO SEIYAKU CO., LTD., Neogen R): 10 parts
Ion-exchanged water: 150 parts

The above-described materials are mixed together in a 1000 ml I-Boy wide-mouthed bottle (manufactured by AS ONE Corporation, polypropylene); 300 parts of zirconia beads having a diameter of 3 mm are added; a ball mill rotating stand (manufactured by Asahi-rika Co., Ltd.) is used to subject the mixed liquid to a rotation treatment at 300 rpm for 24 hours; a stainless steel sieve is used to remove the beads from the dispersion liquid; subsequently, ion-exchanged water is added to provide a white-coloring-agent-particle dispersion liquid (1) having a solid content of 40%. A laser diffraction particle size distribution analyzer is used to measure the white-coloring-agent-particle dispersion liquid (1) and the particles are found to have a volume-average particle size of 500 nm.

### Preparation of Styrene-Acrylic-Resin-Particle Dispersion Liquid (1)

Styrene: 200 parts
n-Butyl acrylate: 50 parts
Acrylic acid: 1 part
O-carboxyethyl acrylate: 3 parts
Propanediol diacrylate: 1 part
2-Hydroxyethyl acrylate: 0.5 parts
Dodecanethiol: 1 part

Into a flask, a solution in which 4 parts of an anionic surfactant (manufactured by The Dow Chemical Company, Dowfax) is dissolved in 550 parts of ion-exchanged water is placed; into this, a mixed liquid prepared by mixing together the above-described raw materials is placed and emulsified. Into the emulsion under slow stirring for 10 minutes, 50 parts of ion-exchanged water in which 6 parts of ammonium persulfate is dissolved is placed. Subsequently, the system is sufficiently purged with nitrogen; the system is heated in an oil bath until the internal temperature reaches 75° C. and polymerization is caused for 30 minutes.
Styrene: 110 parts
n-Butyl acrylate: 50 parts
β-carboxyethyl acrylate: 5 parts
1,10-Decanediol diacrylate: 2.5 parts
Dodecanethiol: 2 parts

Subsequently, a mixed liquid prepared by mixing together the above-described raw materials is added and emulsified; the emulsion is added to the flask for 120 minutes and, in this state, emulsion polymerization is continuously caused for 4 hours. This provides a resin particle dispersion liquid in which resin particles having a weight-average molecular weight of 32,000, a glass transition temperature of 53° C., and a volume-average particle size of 240 nm are dispersed. To the resin particle dispersion liquid, ion-exchanged water is added so as to adjust the solid content to 20%, to provide a styrene-acrylic-resin-particle dispersion liquid (1).

### Preparation of Release-Agent-Particle Dispersion Liquid (1)

Paraffin wax (manufactured by NIPPON SEIRO CO., LTD., HNP9, melting temperature: 72° C.): 90 parts
Anionic surfactant (manufactured by DAI-ICHI KOGYO SEIYAKU CO., LTD., Neogen R): 3.6 parts
Ion-exchanged water: 360 parts

The above-described materials are mixed together, heated to 100° C. to dissolve the wax, subsequently subjected to a dispersing treatment using a pressure discharge homogenizer (manufactured by Gaulin company, Gaulin homogenizer) at a dispersing pressure of 5 MPa for 2 hours, and subsequently subjected to a dispersing treatment at a dispersing pressure of 40 MPa for 3 hours, to provide a release-agent-particle dispersion liquid (1) having a solid content of 20%. In the release-agent-particle dispersion liquid (1), the particles are found to have a volume-average particle size of 230 nm.

### Preparation of Carrier

Ferrite particles (volume-average particle size: 35 μm): 100 parts
Toluene: 14 parts
Styrene/methyl methacrylate copolymer (copolymerization ratio: 15/85): 3 parts
Carbon black (Cabot Corporation, Regal330): 0.2 parts

The above-described materials except for the ferrite particles are dispersed in a sand mill to prepare a dispersion liquid; this dispersion liquid together with the ferrite particles are placed into a vacuum degassing kneader, and dried under stirring and under a reduced pressure to thereby provide a carrier.

### Example 1

### Preparation of White Toner Particles (1)

Ion-exchanged water: 400 parts
Styrene-acrylic-resin-particle dispersion liquid (1): 200 parts
White-coloring-agent-particle dispersion liquid (1): 40 parts
Release-agent-particle dispersion liquid (1): 12 parts Anionic surfactant (manufactured by TAYCA CORPORATION, TaycaPower): 5 parts

The above-described components are placed into a reaction vessel equipped with a thermometer, a pH meter, and a stirrer, and, under temperature control using a heating mantle disposed outside, held at a temperature of 30° C. and at a stirring rotation rate of 150 rpm for 30 minutes. To the mixture being dispersed using a homogenizer (manufactured by IKA JAPAN: ULTRA-TURRAX T50) at 5000 rpm for 15 minutes, an aqueous PAC solution prepared by dissolving 2.1 parts of polyaluminum chloride (PAC, manufactured by Oji Paper Co., Ltd.: 30% powder product) in 100 parts of ion-exchanged water is added. Subsequently, the mixture is heated to 53° C. under stirring at a stirring rotation rate of 500 rpm; a Coulter Multisizer II (aperture diameter: 50 μm, manufactured by Coulter, Inc.) is used to measure the particle sizes and the volume-average particle size is set to 7.4 μm. Subsequently, 115 parts of the resin particle dispersion liquid (1) is further added, to cause the resin particles to adhere to the surfaces of aggregate particles (shell structure). Subsequently, 20 parts of a 10% aqueous solution of NTA (nitrilotriacetic acid) metal acid (CHELEST 70: manufactured by CHELEST CORPORATION) is added, and subsequently a 1 N aqueous sodium hydroxide solution is used to adjust the pH to 9.0. Subsequently, the mixture is heated at a temperature increase rate of 0.05° C./min to 91° C. and held at 91° C. for 135 minutes; subsequently, the resultant toner slurry is cooled to 85° C. and held for 1 hour. Subsequently, the toner slurry is cooled to 25° C. A process of dispersing again the toner slurry in ion-exchanged water and filtered is repeated and the toner slurry is rinsed until the electric conductivity of the filtrate reaches 20 μS/cm or less; and subsequently the toner slurry is vacuum-dried in an oven at 40° C. for 5 hours, to provide white toner particles (1). The white toner particles (1) are found to have a volume-average particle size of 8.52 μm.

### Preparation of White Toner (1) and White Developer (1)

To 100 parts of the white toner particles (1), 0.25 parts of polymethyl methacrylate particles having a volume-average particle size of 483 nm and serving as the poly(meth)acrylate particles, and 1.0 part of sol-gel silica particles having a volume-average particle size of 96 nm and serving as the silica particles are added, and mixed together using a Henschel mixer at a stirring peripheral velocity of 30 m/s for 15 minutes. Subsequently, the mixture is sieved through a vibratory sieve having an aperture size of 45 μm to provide a white toner (1).

Into a V blender, 10 parts of the white toner (1) and 100 parts of the carrier are placed and stirred for 20 minutes. Subsequently, the mixture is sieved through a sieve having an aperture size of 212 μm to provide a white developer (1).

### Examples 2 to 32 and Comparative Examples 1 to 8

For the preparation of the white toner particles (1) of Example 1, various production conditions (for example, the temperature increase rate during aggregation of resin particles, the pH adjustment during fusion-coalescence of aggregate particles, the fusion-coalescence temperature of aggregate particles, or the fusion-coalescence end time of aggregate particles) are appropriately changed, to provide white toner particles of Examples 2 to 32 and Comparative Examples 1 to 8 having properties in Table 1.

Subsequently, for the preparation of the white toner (1) of Example 1, changes to white toner particles of Examples 2 to 32 and Comparative Examples 1 to 8 having properties in Table 1 and polymethyl methacrylate particles and sol-gel silica particles having external addition amounts and volume-average particle sizes in Table 1 are performed, to provide white toners of Examples 2 to 32 and Comparative Examples 1 to 8.

Subsequently, the toners of Examples 2 to 32 and Comparative Examples 1 to 8 are used as in the white developer of Example 1, to provide white developers of Examples 2 to 32 and Comparative Examples 1 to 8.

Note that the properties of the white toner particles and the conditions of the external additives in Table 1 are as follows.
Volume-average particle size D_{50W} of white toner particles
Specific surface area S_{W} of white toner particles
Average circularity R_{W} of white toner particles
Ratio A_{W3.2} of white toner particles having particle size of 3.2 μm or less
Average circularity R_{W3.2} of white toner particles having particle size of 3.2 μm or less
Volume-average particle size D_{50PMMA} of polymethyl methacrylate particles
External addition amount M_{PMMA_W} of polymethyl methacrylate particles
Volume-average particle size D_{50S} of sol-gel silica particles
External addition amount M_{S} of sol-gel silica particles

Note that, in Tables, the polymethyl methacrylate particles will be referred to as PMMA particles.

In addition, the sol-gel silica particles will be referred to as Sol-gel silica particles.

### Evaluation of Whiteness of White Images Before and After of Low-Area-Coverage Continuous Image Formation

### Formation of White Images Using White Developers

The white developer of each of Examples and Comparative Examples is placed into the white developing device of an electrophotographic image forming apparatus (“Iridesse” manufactured by FUJIFILM Business Innovation Corp.).

This image forming apparatus is used to form a white image on a single Kishu Black paper sheet (grammage: 124 gsm). The white image is adjusted so as to have a toner mass per unit area of 9.0 g/m² on the photoreceptor.

Formation of White Images after Low-Area-Coverage Continuous Image Formation

The white developer of each of Examples and Comparative Examples is placed into the white developing device of an electrophotographic image forming apparatus (“Iridesse” manufactured by FUJIFILM Business Innovation Corp.).

This image forming apparatus is used to continuously form white images having an area coverage of 0.5% on 500 paper sheets; this process is repeated 20 times, to form white images having an area coverage of 0.5% on 10000 paper sheets in total.

Subsequently, a white image is formed on a single Kishu Black paper sheet (grammage: 124 gsm). The white image is adjusted so as to have a toner mass per unit area of 9.0 g/m² on the photoreceptor.

### Measurement of Whiteness of White Images Before and After Low-Area-Coverage Continuous Image Formation

A spectrophotometer (X-Rite Ci62, manufactured by X-Rite Inc.) is used under a D50 light source to measure, as the whiteness of the white image, the L* value (lightness).

The whiteness L*¹ of the white image before the low-area-coverage continuous image formation and the whiteness L*² of the white image after the low-area-coverage continuous image formation are evaluated on the basis of the following grades and the difference between the whitenesses, ΔL*=L*¹−L*², is also evaluated on the basis of the following grades.

### Grades of Whiteness

A: the L* value is 75 or more
B: the L* value is 72 or more and less than 75
C: the L* value is 69 or more and less than 72
D: the L* value is 65 or more and less than 69
E: the L* value is less than 65

### Grades of ΔL*

A: ΔL*≤2
B: 2<ΔL*≤4
C: 4<ΔL*≤6
D: 6<ΔL*≤8
E: 8<ΔL*

### Change in Coloration of Color Image During Multiple Transfer of White Image and Color Image

A color image adjusted so as to have a toner mass per unit area of 6.0 g/m² is continuously output on 100 paper sheets; of these, 10 paper sheets are randomly extracted; for 10 points in the surrounding region (10 mm from the edge) of each image and 10 points within the image, X-Rite939 manufactured by X-Rite Inc. (aperture diameter: 4 mm) is used to determine coordinates (L* value, a* value, and b* value) in the CIE 1976 L*a*b* colorimetric system.

Note that, as the output chart for evaluation of the chroma, lightness, and hue-angle of the color image, the image sample of Test chart No. 5-1 of the Imaging Society of Japan is used. Specifically, as the underlying layer of YMCK constituted by yellow (Y), magenta (M), and cyan (C), the white image formed from the white developer (namely, the white toner) of each of Examples and Comparative Examples is output.

The chroma, hue-angle, and lightness of the color image overlying the white image are calculated, from the coordinates (L* value, a* value, and b* value) in the CIE 1976 L*a*b* colorimetric system, by the following formula. The lightness is represented by the index L* value representing lightness in the CIE 1976 (L*, a*, b*) colorimetric system.

Chroma (C*)=((a*)²+(b*)²))^{1/2}

Hue-angle (h)=tan⁻¹(b*/a*)

Note that the hue-angle is described in degrees [° ].

The chroma, hue-angle, and lightness of the color image overlying the white image are evaluated in accordance with evaluation grades below.

The evaluation is performed for the yellow image having the highest lightness. For the reference value of the yellow image, a white image having a contrast ratio of 90% or more, a chroma of 5 or less, and a lightness of 85 or more (and the hue-angle is not limited because the chroma is low) is firstly formed; the values of a yellow image having a toner mass per unit area of 6.0 g/m² output on the white image are used for comparison; the difference (Δ) between the averages of such values is used for evaluation.

Note that the white region and the black region of a contrast ratio test paper sheet described in JIS K5600-4 are laid and a product named as X-Rite938 manufactured by X-Rite Inc. is used to measure the tristimulus values Y of the white image. Subsequently, the Y value measured for the white image on the white region of the contrast ratio test paper sheet is defined as Yw, the Y value measured for the white image on the black region of the contrast ratio test paper sheet is defined as Yb, and the contrast ratio (Yb/Yw) is calculated in percentage.

### Chroma (C)

A: The chroma of the overlying color image is not impaired and is reproduced well (82 or more; ΔC≤12)
B: The chroma of the overlying color image is not impaired and is reproduced (79 or more and less than 82; 12<ΔC≤15)
C: The chroma of the overlying color image is impaired and lowers (less than 79; 15<ΔC)

### Hue-Angle (θ)

A: The hue-angle of the overlying color image is not impaired and is reproduced well (94; Δθ≤1)
B: The hue-angle of the overlying color image is not impaired and is reproduced (1<θ≤4)
C: The hue-angle of the overlying color image is impaired and lowers (4<θ)

### Lightness (L)

A: The lightness of the overlying color image is not impaired and is reproduced well (87 or more; ΔL≤5)
B: The lightness of the overlying color image is not impaired and is reproduced (80 or more and less than 87; 5<ΔL≤12)
C: The lightness of the overlying color image is impaired and lowers (less than 80; 12<ΔL)

### Evaluation of Maximum Color Difference of Color Image

For each of the measured values of the color image, the smaller the color difference ΔE between the maximum value and the minimum value, the higher the color reproducibility.

### Maximum Color Difference (ΔE) of Color Image on White Image

A: The color formation of the overlying color image is not impaired and is reproduced well (ΔE≤3)
B: The color formation of the overlying color image is not impaired and is reproduced (3<ΔE≤4)
C: The color formation of the overlying color image is impaired and degraded (4≤ΔE)

### Evaluation of Color Formation of Color Image

For the measured values of the hue-angle θ of the above-described color image, the smaller the color difference Δθ between the maximum value and the minimum value, the higher the color reproducibility. The results will be described in Table 2. On the basis of the value of the maximum color difference of the color image, the color formation of the color image is evaluated in accordance with the following evaluation grades.

### Evaluation of Color Formation of Color Image (Δθ)

A: The color formation of the overlying color image is not impaired and is reproduced well (Δθ≤2)
B: The color formation of the overlying color image is not impaired and is reproduced (2<Δθ≤5)
C: The color formation of the overlying color image is impaired and degraded (5<Δθ)

### Examples 101 to 111

Of Examples 1 to 111, some white developers are prepared.

On the other hand, yellow developers including yellow toners in which, to yellow toner particles having an average circularity in Table 2, an external addition amount of polymethyl methacrylate particles having a volume-average particle size in Table 2 are externally added are prepared.

The sets of combinations of the white developers and the yellow developers in Table 3 are defined as developer sets (namely, toner sets) of Examples 101 to 111.

In order to examine suppression of degradation of coloration of color images due to, in the white toners and the color toners, the external addition amount of the poly(meth)acrylate particles and the average circularity of toner particles, the developer sets (namely, toner sets) of Examples 101 to 111 are used to perform evaluation of “Change in coloration of color image during multiple transfer of white image and color image”.

TABLE 1

| | White toner particles | | | | | | External additive | | | | |
|---|---|---|---|---|---|---|---|---|---|---|---|
| | All | | | White toner particles | | | PMMA particles | | Sol-gel silica particles | | |
| | | Specific | | having particle size | | | | External | | External | |
| | Particle | surface | | of 3.2 μm or less | | | Particle | addition | particle | addition | |
| | size | area | Circularity | Ratio | Circularity | R_{W}- | size | amount | size | amount | |
| | D_{50W} | S_{w} | R_{W} | A_{W3.2} | R_{W3.2} | R_{W3.2} | D_{50PMMA} | M_{PMMA-W} | D_{50S} | M_{S} | D_{50PMMA}/D_{50S} |
| | μm | cm²/g | — | vol % | — | — | nm | mass % | nm | mass % | — |
| Example 1 | 8.52 | 1.104 | 0.941 | 1.402 | 0.862 | 0.079 | 483 | 0.25 | 96 | 1 | 5.031 |
| Example 2 | 6.01 | 1.192 | 0.938 | 2.987 | 0.871 | 0.067 | 483 | 0.25 | 96 | 1 | 5.031 |
| Example 3 | 9.98 | 1.032 | 0.949 | 0.521 | 0.852 | 0.097 | 483 | 0.25 | 96 | 1 | 5.031 |
| Example 4 | 8.48 | 1.062 | 0.94 | 0.503 | 0.859 | 0.081 | 483 | 0.25 | 96 | 1 | 5.031 |
| Example 5 | 8.47 | 1.071 | 0.938 | 0.6 | 0.861 | 0.077 | 483 | 0.25 | 96 | 1 | 5.031 |
| Example 6 | 8.35 | 1.138 | 0.933 | 2.486 | 0.87 | 0.063 | 483 | 0.25 | 96 | 1 | 5.031 |
| Example 7 | 8.43 | 1.154 | 0.932 | 2.987 | 0.872 | 0.06 | 483 | 0.25 | 96 | 1 | 5.031 |
| Example 8 | 9.86 | 0.703 | 0.958 | 0.513 | 0.87 | 0.088 | 483 | 0.25 | 96 | 1 | 5.031 |
| Example 9 | 6.2 | 1.198 | 0.929 | 0.61 | 0.842 | 0.087 | 483 | 0.25 | 96 | 1 | 5.031 |
| Example 10 | 8.52 | 1.104 | 0.941 | 1.402 | 0.862 | 0.079 | 483 | 0.1 | 96 | 1 | 5.031 |
| Example 11 | 8.52 | 1.104 | 0.941 | 1.402 | 0.862 | 0.079 | 483 | 2 | 96 | 1 | 5.031 |
| Example 12 | 8.52 | 1.104 | 0.941 | 1.402 | 0.862 | 0.079 | 299 | 0.25 | 96 | 1 | 3.115 |
| Example 13 | 8.52 | 1.104 | 0.941 | 1.402 | 0.862 | 0.079 | 302 | 0.25 | 96 | 1 | 3.146 |
| Example 14 | 8.52 | 1.104 | 0.941 | 1.402 | 0.862 | 0.079 | 596 | 0.25 | 96 | 1 | 6.208 |
| Example 15 | 8.52 | 1.104 | 0.941 | 1.402 | 0.862 | 0.079 | 602 | 0.25 | 96 | 1 | 6.271 |
| Example 16 | 8.52 | 1.104 | 0.941 | 1.402 | 0.862 | 0.079 | 483 | 0.25 | 78 | 1 | 6.192 |
| Example 17 | 8.52 | 1.104 | 0.941 | 1.402 | 0.862 | 0.079 | 483 | 0.25 | 81 | 1 | 5.963 |
| Example 18 | 8.52 | 1.104 | 0.941 | 1.402 | 0.862 | 0.079 | 483 | 0.25 | 118 | 1 | 4.093 |
| Example 19 | 8.52 | 1.104 | 0.941 | 1.402 | 0.862 | 0.079 | 483 | 0.25 | 122 | 1 | 3.959 |
| Example 20 | 8.52 | 1.104 | 0.941 | 1.402 | 0.862 | 0.079 | 287 | 0.25 | 122 | 1 | 2.352 |
| Example 21 | 8.52 | 1.104 | 0.941 | 1.402 | 0.862 | 0.079 | 302 | 0.25 | 118 | 1 | 2.559 |
| Example 22 | 8.52 | 1.104 | 0.941 | 1.402 | 0.862 | 0.079 | 596 | 0.25 | 81 | 1 | 7.358 |
| Example 23 | 8.52 | 1.104 | 0.941 | 1.402 | 0.862 | 0.079 | 605 | 0.25 | 77 | 1 | 7.857 |
| Example 24 | 8.52 | 1.104 | 0.941 | 1.402 | 0.862 | 0.079 | 483 | 0.25 | 96 | 0.78 | 5.031 |
| Example 25 | 8.52 | 1.104 | 0.941 | 1.402 | 0.862 | 0.079 | 483 | 0.25 | 96 | 0.82 | 5.031 |
| Example 26 | 8.52 | 1.104 | 0.941 | 1.402 | 0.862 | 0.079 | 483 | 0.25 | 96 | 2.98 | 5.031 |
| Example 27 | 8.52 | 1.104 | 0.941 | 1.402 | 0.862 | 0.079 | 483 | 0.25 | 96 | 3.02 | 5.031 |
| Example 28 | 8.48 | 0.987 | 0.922 | 2.083 | 0.93 | −0.008 | 483 | 0.25 | 96 | 1 | 5.031 |
| Example 29 | 8.51 | 1.054 | 0.943 | 1.503 | 0.892 | 0.051 | 483 | 0.25 | 96 | 1 | 5.031 |
| Example 30 | 8.53 | 1.069 | 0.943 | 1.429 | 0.895 | 0.048 | 483 | 0.25 | 96 | 1 | 5.031 |
| Example 31 | 8.38 | 1.147 | 0.947 | 1.789 | 0.848 | 0.099 | 483 | 0.25 | 96 | 1 | 5.031 |
| Example 32 | 8.36 | 1.154 | 0.947 | 1.807 | 0.846 | 0.101 | 483 | 0.25 | 96 | 1 | 5.031 |
| Comparative | 5.97 | 1.198 | 0.941 | 1.402 | 0.862 | 0.079 | 483 | 0.25 | 96 | 1 | 5.031 |
| Example 1 | | | | | | | | | | | |
| Comparative | 10.04 | 0.987 | 0.941 | 1.402 | 0.862 | 0.079 | 483 | 0.25 | 96 | 1 | 5.031 |
| Example 2 | | | | | | | | | | | |
| Comparative | 8.45 | 1.059 | 0.948 | 0.497 | 0.864 | 0.084 | 483 | 0.25 | 96 | 1 | 5.031 |
| Example 3 | | | | | | | | | | | |
| Comparative | 8.39 | 1.167 | 0.937 | 3.004 | 0.865 | 0.072 | 483 | 0.25 | 96 | 1 | 5.031 |
| Example 4 | | | | | | | | | | | |
| Comparative | 9.87 | 0.698 | 0.96 | 0.505 | 0.871 | 0.089 | 483 | 0.25 | 96 | 1 | 5.031 |
| Example 5 | | | | | | | | | | | |
| Comparative | 6.13 | 1.204 | 0.925 | 2.993 | 0.841 | 0.084 | 483 | 0.25 | 96 | 1 | 5.031 |
| Example 6 | | | | | | | | | | | |
| Comparative | 8.52 | 1.104 | 0.941 | 1.402 | 0.862 | 0.079 | 483 | 0.08 | 96 | 1 | 5.031 |
| Example 7 | | | | | | | | | | | |
| Comparative | 8.52 | 1.104 | 0.941 | 1.402 | 0.862 | 0.079 | 483 | 2.02 | 96 | 1 | 5.031 |
| Example 8 | | | | | | | | | | | |

TABLE 2

| | Evaluation | | | | | | | |
|---|---|---|---|---|---|---|---|---|
| | | | | Change in coloration of color image during multiple | | | | |
| | | | | transfer of white image and color image | | | | |
| | Whiteness of white images | | | | | | Maximum color | Evaluation |
| | before and after low-area-coverage | | | Color image | | | difference of | of color |
| | continuous image formation | | | | | Hue- | color image on | formation of |
| | L*¹ | L*² | ΔL* = L*¹ − L*² | Lightness | Chroma | angle° | white image | color image |
| Example 1 | 80(A) | 78(A) | 2(A) | A | A | A | A | A |
| Example 2 | 75(B) | 72(B) | 3(B) | A | A | A | A | A |
| Example 3 | 84(A) | 81(A) | 3(B) | B | A | A | A | A |
| Example 4 | 81(A) | 78(A) | 3(B) | A | B | A | A | A |
| Example 5 | 80(A) | 77(A) | 3(B) | A | B | A | A | A |
| Example 6 | 79(A) | 75(A) | 3(B) | A | A | A | B | A |
| Example 7 | 78(A) | 74(B) | 4(B) | A | A | A | B | A |
| Example 8 | 86(A) | 82(A) | 4(B) | A | A | A | A | B |
| Example 9 | 74(B) | 72(B) | 2(A) | A | B | A | A | A |
| Example 10 | 79(A) | 75(A) | 4(B) | A | A | B | A | B |
| Example 11 | 83(A) | 82(A) | 1(A) | A | A | A | A | A |
| Example 12 | 77(A) | 73(B) | 4(B) | A | A | B | A | B |
| Example 13 | 78(A) | 74(B) | 4(B) | A | B | A | A | A |
| Example 14 | 81(A) | 77(A) | 4(B) | B | | A | A | A |
| Example 15 | 82(A) | 78(A) | 4(B) | A | B | A | A | A |
| Example 16 | 78(A) | 74(B) | 4(B) | A | A | B | A | B |
| Example 17 | 79(A) | 75(A) | 4(B) | A | B | A | A | A |
| Example 18 | 80(A) | 76(A) | 4(B) | A | B | A | A | A |
| Example 19 | 81(A) | 77(A) | 4(B) | B | A | A | A | A |
| Example 20 | 78(A) | 74(B) | 4(B) | B | B | A | B | B |
| Example 21 | 79(A) | 76(A) | 3(B) | A | A | B | B | A |
| Example 22 | 80(A) | 77(A) | 3(B) | B | B | A | A | B |
| Example 23 | 81(A) | 77(A) | 4(B) | B | B | B | B | B |
| Example 24 | 78(A) | 74(B) | 4(B) | A | B | A | B | A |
| Example 25 | 79(A) | 75(A) | 4(B) | B | A | A | A | B |
| Example 26 | 80(A) | 78(A) | 2(A) | A | A | A | B | A |
| Example 27 | 80(A) | 78(A) | 2(A) | A | A | A | A | B |
| Example 28 | 82(A) | 78(A) | 4(B) | B | B | A | A | A |
| Example 29 | 82(A) | 78(A) | 4(B) | A | B | A | A | A |
| Example 30 | 82(A) | 78(A) | 4(B) | A | A | B | A | A |
| Example 31 | 76(A) | 72(B) | 4(B) | B | B | A | A | B |
| Example 32 | 76(A) | 72(B) | 4(B) | B | B | B | A | A |
| Comparative | 74(B) | 70(C) | 4(B) | B | B | B | A | B |
| Example 1 | | | | | | | | |
| Comparative | 86(A) | 81(A) | 5(C) | A | A | A | B | B |
| Example 2 | | | | | | | | |
| Comparative | 83(A) | 81(A) | 2(B) | A | A | A | B | C |
| Example 3 | | | | | | | | |
| Comparative | 76(A) | 70(C) | 6(C) | B | B | C | B | B |
| Example 4 | | | | | | | | |
| Comparative | 87(A) | 82(A) | 5(C) | A | A | A | A | B |
| Example 5 | | | | | | | | |
| Comparative | 73(B) | 69(C) | 4(B) | B | B | C | B | B |
| Example 6 | | | | | | | | |
| Comparative | 78(A) | 73(B) | 5(C) | A | A | B | B | B |
| Example 7 | | | | | | | | |
| Comparative | 81(A) | 80(A) | 1(A) | A | A | B | C | B |
| Example 8 | | | | | | | | |

TABLE 3

| | | | External additive of white toner | | | | | | External additive of yellow toner | | | | |
|---|---|---|---|---|---|---|---|---|---|---|---|---|---|
| | | | | | Sol-gel silica | | Yellow toner | | | | Sol-gel silica | | |
| | | White toner | PMMA particles | | particles | | particles | | PMMA particles | | particles | | |
| | Type of | particles | | External | Par- | External | All | | | External | | External | |
| | white | All | Particle | addition | ticle | addition | Circu- | | Particle | addition | Particle | addition | |
| | developer | Circularity | size | amount | size | amount | larity | | size | amount | size | amount | M_{PMMA-W}- |
| | (No. of | R_{W} (=SF_{W}) | D_{50PMMA} | M_{PMIMA-W} | D_{50S} | E_{S} | SF_{C} | SF_{C}- | D_{50PMMA} | M_{PMMA-C} | D_{50S} | E_{S} | M_{PMIMA-C} |
| | Examples) | — | nm | mass % | nm | mass % | — | SF_{W} | nm | mass % | nm | mass % | — |
| Exam- | Example | 0.941 | 483 | 0.25 | 96 | 1 | 0.963 | 0.022 | 483 | 0.11 | 96 | 1.2 | 0.14 |
| ple 101 | 1 | | | | | | | | | | | | |
| Exam- | Example | 0.941 | 483 | 0.1 | 96 | 1 | 0.963 | 0.022 | 483 | 0.11 | 96 | 1.2 | −0.01 |
| ple 102 | 10 | | | | | | | | | | | | |
| Exam- | Example | 0.941 | 483 | 0.1 | 96 | 1 | 0.963 | 0.022 | 483 | 0.075 | 96 | 1.2 | 0.025 |
| ple 103 | 10 | | | | | | | | | | | | |
| Exam- | Example | 0.941 | 483 | 0.1 | 96 | 1 | 0.963 | 0.022 | 483 | 0.08 | 96 | 1.2 | 0.02 |
| ple 104 | 10 | | | | | | | | | | | | |
| Exam- | Example | 0.941 | 483 | 0.25 | 96 | 1 | 0.963 | 0.022 | 483 | 0 | 96 | 1.2 | 0.25 |
| ple 105 | 1 | | | | | | | | | | | | |
| Exam- | Example | 0.941 | 483 | 2 | 96 | 1 | 0.963 | 0.022 | 483 | 0.11 | 96 | 1.2 | 1.89 |
| ple 106 | 11 | | | | | | | | | | | | |
| Exam- | Example | 0.958 | 483 | 0.25 | 96 | 1 | 0.953 | −0.005 | 483 | 0.11 | 96 | 1.2 | 0.14 |
| ple 107 | 8 | | | | | | | | | | | | |
| Exam- | Example | 0.943 | 483 | 0.25 | 96 | 1 | 0.963 | 0.02 | 483 | 0.11 | 96 | 1.2 | 0.14 |
| ple 108 | 30 | | | | | | | | | | | | |
| Exam- | Example | 0.941 | 483 | 0.25 | 96 | 1 | 0.963 | 0.022 | 483 | 0.11 | 96 | 1.2 | 0.14 |
| ple 109 | 1 | | | | | | | | | | | | |
| Exam- | Example | 0.929 | 483 | 0.25 | 96 | 1 | 0.963 | 0.034 | 483 | 0.11 | 96 | 1.2 | 0.14 |
| ple 110 | 9 | | | | | | | | | | | | |
| Exam- | Example | 0.922 | 483 | 0.25 | 96 | 1 | 0.963 | 0.041 | 483 | 0.11 | 96 | 1.2 | 0.14 |
| ple 111 | 28 | | | | | | | | | | | | |
| | | | | | | | | | Evaluation | | | | |
| | | | | | | | | | Change in coloration of color image | | | | |
| | | | | | | | | | during multiple transfer of white | | | | |
| | | | | | | | | | image and color image | | | | |
| | | | | | | | | | | | | Maximum | |
| | | | | | | | | | | | | color | Eval- |
| | | | | | | | | Type of | | | | difference | uation |
| | | | | | | | | white | | | | of color | of color |
| | | | | | | | | developer | Color image | | | image on | formation |
| | | | | | | | | (No. of | Light- | | Hue- | white | of color |
| | | | | | | | | Examples) | ness | Chroma | angle° | image | image |
| | | | | | | | Exam- | Example | A | A | A | A | A |
| | | | | | | | ple 101 | 1 | | | | | |
| | | | | | | | Exam- | Example | B | B | B | B | B |
| | | | | | | | ple 102 | 10 | | | | | |
| | | | | | | | Exam- | Example | B | B | A | B | A |
| | | | | | | | ple 103 | 10 | | | | | |
| | | | | | | | Exam- | Example | A | B | A | B | A |
| | | | | | | | ple 104 | 10 | | | | | |
| | | | | | | | Exam- | Example | B | B | A | B | A |
| | | | | | | | ple 105 | 1 | | | | | |
| | | | | | | | Exam- | Example | A | A | A | A | A |
| | | | | | | | ple 106 | 11 | | | | | |
| | | | | | | | Exam- | Example | B | B | B | B | B |
| | | | | | | | ple 107 | 8 | | | | | |
| | | | | | | | Exam- | Example | A | B | B | A | A |
| | | | | | | | ple 108 | 30 | | | | | |
| | | | | | | | Exam- | Example | A | A | B | A | A |
| | | | | | | | ple 109 | 1 | | | | | |
| | | | | | | | Exam- | Example | A | B | A | B | A |
| | | | | | | | ple 110 | 9 | | | | | |
| | | | | | | | Exam- | Example | B | B | A | B | A |
| | | | | | | | ple 111 | 28 | | | | | |

The above-described results demonstrate that, compared with Comparative Examples, Examples provide, even in repeated formation of low-area-coverage images, white images in which lowering of the whiteness is suppressed.

The results also demonstrate that, compared with Comparative Examples, Examples suppress degradation of coloration of color images.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An electrostatic image developing white toner comprising:
white toner particles including a binder resin and a white coloring agent; and
an external additive including poly(meth)acrylate particles,
wherein the white toner particles have a volume-average particle size D_{50W} of 6.0 μm or more and 10 μm or less,
a ratio of the white toner particles having a particle size of 3.2 μm or less relative to all the white toner particles is 0.5 vol % or more and 3 vol % or less,
the white toner particles have a specific surface area S_{w} of 0.7 cm²/g or more and 1.2 cm²/g or less, and
an external addition amount of the poly(meth)acrylate particles relative to the white toner particles is 0.1 mass % or more and 2.0 mass % or less.
   (((2)))

The electrostatic image developing white toner according to (((1))), wherein the ratio of the white toner particles having a particle size of 3.2 μm or less relative to all the white toner particles is 0.6 vol % or more and 2.5 vol % or less.

(((3)))

The electrostatic image developing white toner according to (((1))) or (((2))), wherein the poly(meth)acrylate particles have a volume-average particle size of 300 nm or more and 600 nm or less.

(((4)))

The electrostatic image developing white toner according to (((1))), wherein the external additive includes silica particles having a volume-average particle size of 80 nm or more and 120 nm or less.

(((5)))

The electrostatic image developing white toner according to (((4))), wherein a relation between a volume-average particle size D_{50S} of the silica particles and a volume-average particle size D_{50PMMA} of the poly(meth)acrylate particles satisfies a relation of 2.5<D_{50PMMA}/D_{50S}<7.5.

(((6)))

The electrostatic image developing white toner according to (((4))) or (((5))), wherein an external addition amount of the silica particles relative to the white toner particles is 0.8 mass % or more and 3.0 mass % or less.

(((7)))

The electrostatic image developing white toner according to any one of (((1))) to (((6))), wherein a relation between an average circularity R_{W} of the white toner particles and an average circularity R_{W3.2} of the white toner particles having a particle size of 3.2 μm or less satisfies a relation of R_{W3.2}<R_{W}.

(((8)))

The electrostatic image developing white toner according to (((7))), wherein the relation between the average circularity R_{W} of the white toner particles and the average circularity R_{W3.2} of the white toner particles having a particle size of 3.2 μm or less satisfies a relation of 0.05<R_{W}-R_{W3.2}<0.1.

(((9)))

An electrostatic image white developer comprising the electrostatic image developing white toner according to any one of (((1))) to (((8))).

(((10)))

A white toner cartridge comprising the electrostatic image developing white toner according to any one of (((1))) to (((8))),
wherein the white toner cartridge is attachable to and detachable from an image forming apparatus.
   (((11)))

A process cartridge comprising a development section that contains the electrostatic image white developer according to (((9))) and uses the electrostatic image white developer to develop an electrostatic image formed on a surface of an image holding member to form a toner image,
wherein the process cartridge is attachable to and detachable from an image forming apparatus.
   (((12)))

An image forming apparatus comprising:
an image holding member;
a charging section that charges a surface of the image holding member;
an electrostatic image forming section that forms, on the charged surface of the image holding member, an electrostatic image;
a development section that contains the electrostatic image white developer according to (((9))) and uses the electrostatic image white developer to develop the electrostatic image formed on the surface of the image holding member to form a toner image;
a transfer section that transfers the toner image formed on the surface of the image holding member onto a surface of a recording medium; and
a fixing section that fixes the toner image transferred onto the surface of the recording medium.
   (((13)))

An image forming method comprising:
charging a surface of an image holding member;
forming an electrostatic image on the charged surface of the image holding member;
developing, using the electrostatic image white developer according to (((9))), the electrostatic image formed on the surface of the image holding member to form a toner image;
transferring the toner image formed on the surface of the image holding member onto a surface of a recording medium; and
fixing the toner image transferred onto the surface of the recording medium.
   (((14)))

An electrostatic image developing toner set comprising:
the electrostatic image developing white toner according to any one of (((1))) to (((8))), and
an electrostatic image developing color toner including non-white color toner particles.
   (((15)))

The electrostatic image developing toner set according to (((14))), wherein the electrostatic image developing color toner includes an external additive including poly(meth)acrylate particles, and
a relation between an external addition amount M_{PMMA_W} of the poly(meth)acrylate particles of the electrostatic image developing white toner and an external addition amount M_{PMMA-C} of the poly(meth)acrylate particles of the electrostatic image developing color toner satisfies a relation of M_{PMMA-C}<M_{PMMA-W}.
   (((16)))

The electrostatic image developing toner set according to (((15))), wherein the relation between the external addition amount M_{PMMA_W} of the poly(meth)acrylate particles of the electrostatic image developing white toner and the external addition amount M_{PMMA_C} of the poly(meth)acrylate particles of the electrostatic image developing color toner satisfies a relation of 0.02 mass %<M_{PMMA-W}-M_{PMMA-C}<0.3 mass %.

(((17)))

The electrostatic image developing toner set according to (((14))) or (((16))), wherein a relation between an average circularity SF_{W} of the white toner particles and an average circularity SF_{C} of the color toner particles satisfies a relation of SF_{W}<SF_{C}.

(((18)))

The electrostatic image developing toner set according to (((17))), wherein the relation between the average circularity SF_{W} of the white toner particles and the average circularity SF_{C} of the color toner particles satisfies a relation of 0.02<SF_{C}-SF_{W}<0.04.

What is claimed is:

1. An electrostatic image developing white toner comprising:
white toner particles including a binder resin and a white coloring agent; and
an external additive including poly(meth)acrylate particles,
wherein the white toner particles have a volume-average particle size D_{50W} of 6.0 μm or more and 10 μm or less,
a ratio of the white toner particles having a particle size of 3.2 μm or less relative to all the white toner particles is 0.5 vol % or more and 3 vol % or less,
the white toner particles have a specific surface area S_{W} of 0.7 cm²/g or more and 1.2 cm²/g or less, and
an external addition amount of the poly(meth)acrylate particles relative to the white toner particles is 0.1 mass % or more and 2.0 mass % or less.

2. The electrostatic image developing white toner according to claim 1, wherein the ratio of the white toner particles having a particle size of 3.2 μm or less relative to all the white toner particles is 0.6 vol % or more and 2.5 vol % or less.

3. The electrostatic image developing white toner according to claim 1, wherein the poly(meth)acrylate particles have a volume-average particle size of 300 nm or more and 600 nm or less.

4. The electrostatic image developing white toner according to claim 1, wherein the external additive includes silica particles having a volume-average particle size of 80 nm or more and 120 nm or less.

5. The electrostatic image developing white toner according to claim 4, wherein a relation between a volume-average particle size D_{50S} of the silica particles and a volume-average particle size D_{50PMMA} of the poly(meth)acrylate particles satisfies a relation of 2.5<D_{50PMMA}/D_{50S}<7.5.

6. The electrostatic image developing white toner according to claim 4, wherein an external addition amount of the silica particles relative to the white toner particles is 0.8 mass % or more and 3.0 mass % or less.

7. The electrostatic image developing white toner according to claim 1, wherein a relation between an average circularity R_{W} of the white toner particles and an average circularity R_{W3.2} of the white toner particles having a particle size of 3.2 μm or less satisfies a relation of R_{W3.2}<R_{W}.

8. The electrostatic image developing white toner according to claim 7, wherein the relation between the average circularity R_{W} of the white toner particles and the average circularity R_{W3.2} of the white toner particles having a particle size of 3.2 μm or less satisfies a relation of 0.05<R_{W}-R_{W3.2}<0.1.

9. An electrostatic image white developer comprising the electrostatic image developing white toner according to claim 1.

10. An electrostatic image white developer comprising the electrostatic image developing white toner according to claim 2.

11. An electrostatic image white developer comprising the electrostatic image developing white toner according to claim 3.

12. A white toner cartridge comprising the electrostatic image developing white toner according to claim 1,
wherein the white toner cartridge is attachable to and detachable from an image forming apparatus.

13. A process cartridge comprising a development section that contains the electrostatic image white developer according to claim 9 and uses the electrostatic image white developer to develop an electrostatic image formed on a surface of an image holding member to form a toner image,
wherein the process cartridge is attachable to and detachable from an image forming apparatus.

14. An image forming apparatus comprising:
an image holding member;
a charging section that charges a surface of the image holding member;
an electrostatic image forming section that forms, on the charged surface of the image holding member, an electrostatic image;
a development section that contains the electrostatic image white developer according to claim 9 and uses the electrostatic image white developer to develop the electrostatic image formed on the surface of the image holding member to form a toner image;
a transfer section that transfers the toner image formed on the surface of the image holding member onto a surface of a recording medium; and
a fixing section that fixes the toner image transferred onto the surface of the recording medium.

15. An image forming method comprising:
charging a surface of an image holding member;
forming an electrostatic image on the charged surface of the image holding member;
developing, using the electrostatic image white developer according to claim 9, the electrostatic image formed on the surface of the image holding member to form a toner image;
transferring the toner image formed on the surface of the image holding member onto a surface of a recording medium; and
fixing the toner image transferred onto the surface of the recording medium.

16. An electrostatic image developing toner set comprising:
the electrostatic image developing white toner according to claim 1, and
an electrostatic image developing color toner including non-white color toner particles.

17. The electrostatic image developing toner set according to claim 16, wherein the electrostatic image developing color toner includes an external additive including poly(meth)acrylate particles, and
a relation between an external addition amount M_{PMMA_W} of the poly(meth)acrylate particles of the electrostatic image developing white toner and an external addition amount M_{PMMA-C} of the poly(meth)acrylate particles of the electrostatic image developing color toner satisfies a relation of M_{PMMA-C}<M_{PMMA-W}.

18. The electrostatic image developing toner set according to claim 17, wherein the relation between the external addition amount M_{PMMA_W} of the poly(meth)acrylate particles of the electrostatic image developing white toner and the external addition amount M_{PMMA_C} of the poly(meth)acrylate particles of the electrostatic image developing color toner satisfies a relation of 0.02 mass %<M_{PMMA-W}-M_{PMMA-C}<0.3 mass %.

19. The electrostatic image developing toner set according to claim 16, wherein a relation between an average circularity SF_{W} of the white toner particles and an average circularity SF_{C} of the color toner particles satisfies a relation of SF_{W}<SF_{C}.

20. The electrostatic image developing toner set according to claim 19, wherein the relation between the average circularity SF_{W} of the white toner particles and the average circularity SF_{C} of the color toner particles satisfies a relation of 0.02<SF_{C}-SF_{W}<0.04.
